(19) United States
(12) Patent Application Publication
(10) Pub. No.: US 2006/0155915 A1
(43) Pub. Date: Jul. 13, 2006

(54) Database query processor

(76) Inventor: Jose P. Pereira, Cupertino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/317,781

(22) Filed: Dec. 23, 2005

Related U.S. Application Data
(60) Provisional application No. 60/640,870, filed on Dec. 30, 2004.

(51) Int. Cl. G06F 12/14

(52) U.S. Cl. 711/100

(57) ABSTRACT

Disclosed is an associative content or memory processor for wirespeed query of routing, security string or multi-dimensional lookup tables or databases, which enables high utilization of memory resources and fast updates. The device can operate as binary or ternary CAM (content addressable memory). The device applies parallel processing with spatial and data based partitioning to store multi-dimensional databases with high utilization. One or more CAM blocks are coupled directly to leaf memory or indirectly through mapping stages. The contents of mapping memory are processed by the mapping logic block. The mapping logic processes the stored crossproduct bitmap information to traverse a path to one or more leaf memory storage blocks. The compare block compares the contents of the leaf memory with the search or query key. The output response includes match result, associated data address and associated data.

### CROSS REFERENCE TO RELATED APPLICATIONS

This application claims a benefit of, and priority under 35 USC § 119(e) to, U.S. Provisional Patent Application No. 60/640,870, filed Dec. 30, 2004, and titled “Database Query Processor,” the contents of which are herein incorporated by reference.

### BACKGROUND

1. Field of the Art

The present invention generally relates to information retrieval systems including content addressable memory devices.

2. Description of the Related Art

Content searching is often used to support routing and security functions. Content addressable memory (CAM) devices and memory trie based devices today support packet forwarding and classification in network switches and routers. Today security content processing is supported by deterministic finite automata based methods such as Aho-Corassick with state based memory; or by pattern match and state based memory or by pattern match device (CAM or algorithmic) and memory with matching entry tables with final processing in network processing units (NPU) or equivalent logic devices

Cache and database query systems also require fast location of records or files. These require associative processing of database index tables or cache keyword tables and are currently supported by central processing unit (CPU) caches and various indexing methods (hash, bitmap, trie). These solutions have relatively slow access to records and multiple stages to find necessary data. Performance is increased by often replicating servers with many processors and on chip and off chip cache storage.

The database query processor (DQP) lends itself to the above and other pattern matching applications and enables high capacity content storage, support for complex rules, and high performance query capability. The device supports various methods of fast updates. Database software indexing product such as RightOrder's QueryEdge and CopperEye's Adaptive Indexing demonstrate the limitations of existing database indexing solutions and the need for advanced indexing solutions. CopperEye's white paper on “A Profile of Adaptive Addressing,” and Cooper's “A Fast Index for Semistructured Data,” describe some of the advancements in software indexing. The query processor can thread multiple database operations to realize more complex features such a traffic management, statistics collection and others.

Methods to implement CAMs features such as configurable width and cascading are covered in publications including J. H. Schaffer's Thesis, “Designing Very Large Content-Addressable Memories” pp 11-15. TCAMs are currently very successful in routing applications because they support the requirements described by Bun Mizuhara et al and support multi-dimensional databases; in spite of their high cost, high power and relatively large sizes. M. Kobayashi et al described methods to organize TCAM for LPM (longest prefix matching) in “A Longest Prefix Match Search Engine for Multi-Gigabit IP Processing”. McAuley used the concept of priority to eliminate reordering of Route Entries on Page 8 of “Fast Routing Table Lookups Using CAMs” at Infocom93.

A multi-dimensional database query processor has the conventional requirements to (i) support random distributions of multi-dimensional data, (ii) support overlapping regions of multi-dimensional data; for routing tables these are regions which match due to use of wildcard, (iii) support for dense and sparse tree branches, (iv) optimal use of memory bandwidth, (v) high utilization of memory resources, (vi) support for fast updates including adds and deletes, (vii) during updates; tree restructuring must be very limited, (viii) ability to store multiple entry types in same device, and (ix) support simultaneous search of multiple tables.

Octovian Prokopuic et al's “Bkd-tree, A Dynamic Scalable kd-tree” and in Kaushik Chakrabarti's Thesis describe aspects of requirements i) to vii) in some detail. “IPV6 Capable OC-48 Wire-Rate Packet Forwarding Engine”, by Bun Mizuhara et al, describes routing specific aspects of requirements viii) and ix). The requirement viii) can also include string matching for security applications. The leading references are i) N. Tuck et al's, “Deterministic Memory-Efficient String Matching Algorithms for Intrusion Detection”; and ii) Fang Yu et al's “Gigabit Rate Packet Pattern-Matching Using TCAM”.

Regarding requirement ix): Firstly, as seen from Bun Mizuhara et al it is desirable to be able to perform simultaneous searches on multiple tables using derived keys from an incoming search key. Secondly, for multiple tables with simultaneous search are needed for ranged entries or entries with negation. The DQP can avoid this need for multiple tables by storing negation function and ranging definition in the leaf memory. Huan Liu's “Efficient Mapping of Range Classifier into Ternary-CAM”; shows that for controlled row expansion of ranged entries to TCAM; entries of wider length are needed to store port descriptor fields including range coded values. It is better to create multiple tables in TCAM for each applicable field of Port descriptor; rather than use a wider width and exceed the fixed TCAM width. For example the user could create one table for exact port match: storing exact port value; another table for non-overlapping ranges of port: storing a range identifier, and another table(s) for overlapping port ranges: storing another range coded identifier. Thus it can be inferred from Liu's “Efficient Mapping of Range Classifier into Ternary-CAM,” that multiple database tables may be used to efficiently store and process ranged entries.

TCAM's, however, have a number of disadvantages. For example, TCAMs have a relatively high cost per database entry or record. In addition, TCAMs consume high power due to large area, active signal switching for compare data and match lines. Further, TCAMs have scaling issues with process, high speed and rule complexity (CAMs support a simple rule: typically an XOR function).

Likewise, hash CAM's have a number of disadvantages. For example, hashing can have large overflows and requires many parallel processing blocks for deterministic performance. Moreover, they require large CAMs to store overflows, which cannot be placed in parallel memory blocks. Furthermore, the overflow CAM cannot support complex rules. This limits solutions since an overall solution cannot support complex rules. Other issues include hashing being at best a solution for only one dimensional database; such as IPV4 forwarding. Hashing does not scale for multi-dimensional databases or for databases with advanced query requirements. The thesis on “Managing Large Multidimensional Databases” by Kaushik Chakrabarti highlights that hashing is suited for one dimensional databases. In addition, the cost of hash based solutions is more than tree based solutions even for one dimensional databases because i) hashing causes many collisions and hence require more processing resources, and ii) hashing requires large overflow CAM. U.S. Pat. Nos. 6,697,276, 6,438,674, 6,735,670, 6,671,771 and 5,129,074 describe hash CAM. Two publications (i) by da Silva and Watson and ii) J. H. Schaffer listed in references also describe hash CAM.

Still other solutions being developed also include limitations. New research from David E. Taylor et al, and Sumeet Singh et al, is dramatically better than previous algorithmic solutions for routing applications. However the solutions fail to i) meet the requirements set forth by Bun Mizuhara et al (above) and ii) to support multi-dimensional databases for a wide variety of applications. In addition these approaches do not show how multi-dimensional databases will be stored efficiently; and also do not show how dynamic updates are supported. The solutions described by most recent research and others individually support a few applications and satisfy a small market size. For example pattern matching devices have been developed by Interagon, and Paracel that are used for matching text or bio-informatics patterns. Unfortunately, these devices support limited number of patterns for simultaneous search. In summary many specific devices have been proposed or developed for supporting very niche applications in security string processing or other pattern matching applications. All these do not meet requirements of high capacity, high performance, and fast updates. The only significant alternative for multi-dimensional databases today is CAM (including TCAM) which is relatively successful in routing applications inspite of all its limitations.

Thus, there is a need to develop an architectural solution for an associative processor that accelerates pattern matching applications for database queries, or cache lookups, or routing table lookups, or security and text string lookups, or for high performance computing applications such as bio-informatics database searches. The associative processor, DQP combines intelligent content processing and computation logic to process stored content along with incoming stream. The content storage could be a. state traversal information or b. grammar definition or c. statistical or computing task. This associative processor should elegantly map various routing, security and other cache and multi-dimensional databases; while supporting large capacity, fast updates, and high storage efficiency. An efficient solution with a wide market will provide a low cost and stable product encouraging further usage of such a device.

### SUMMARY

One disclosed embodiment includes is an architecture that achieves high utilization of storage resources and fast retrieval of records. The architecture implements database storage using a trie with BFS (breadth first search) root node and a fixed number of depth search stages. The first stage is a set of parallel CAM (content addressable memory) arrays: configurable width CAM including TCAM (ternary content addressable memory) in the best embodiment. This is followed by zero or many stages of multi-dimensional memory map and mapping logic which eventually point to memory leaf blocks and the compare processing logic. The resulting solution is highly parallel with parallel processing units of CAM arrays (with the BFS root nodes) and multi-dimensional crossproducting in the mapping stages.

The first node of the trie (database retrieval system) is a variable length node supporting the BFS method. The configurable width CAM (TCAM included) enables a variable length, and flexible masking of a multi-dimensional trie root node. This supports both sparse and dense tree branches; sparse branches can use a shorter or node with fewer unmasked bits at first node (CAM); while dense branches of tree can use longer unmasked data bits at the nodes in the first stage (CAM).

The next stage is the associated memory mapping stage. The mapping stages provide flexibility for controllable aggregation and differentiation of multi-dimensional databases. The mapping stages use a crossproduct bitmap logic which implements a multi-dimensional crossproduct of terms to traverse the trie paths. The terms available for crossproducting include all (or substantially all) dimensions of database and significant number of terms are stored in the memory mapping trie so as to achieve a high degree of path selectivity. The differentiation techniques for path selectivity are called upon when the memory bandwidth limits are exceeded by the lowest cost update.

One preferred embodiment of the solution performs packing of memory leaf resources to achieve a high level of utilization. The memory leaf can support multiple or different database as long as the fields are defined and stored. The memory leaf can utilize effective and efficient data structure to represent complex database rules with functions for expressions (NOT, OR), masking of fields, or length masks or string masking: case insensitive or character mask, and order (priority), associated data fields for address or control flags and time stamps, counters and pointers. The memory leaf can store state traversal tables, grammar description, and statistical and computing instructions.

The above architectural features of flexible multi-dimensional indexing eliminate the limitations with hash CAM or trie memory. The embodiments of updates supported in hardware include unbalanced and balanced methods: adding new entries to aggregated tree branches at the leaf nodes; or at the branch node (second or last stage of mapping) or stem (first stage of mapping) node along with the CAM (root) node. In a preferred embodiment, updates affect at most 2 paths within the mapping or leaf nodes. The tree height can be 2 stages (root and leaf), or 3 stages (leaf, branch map, leaf memory), or 4 stages in preferred embodiment (root, stem map, branch map, leaf) or more stages. This very limited restructuring of tree allows fast updates. Updates can use a controller to assist in making update decisions.

One embodiment of an update for addition includes two steps: first, a query on existing database to identify proximal paths and estimate update cost in terms of additional resources and memory bandwidth; and second, the actual storage of the added entry at leaf memory and update of paths in CAM block or mapping stages (stem, branch and other mapping levels if they exist). The update for deletion also uses similar operations. One difference between an add and delete is that an add causes more splits of existing mapping nodes and a delete causes more merges. However, each update includes splitting techniques (data partitioning or differentiation) and merge or aggregation techniques. An update can be a variation of the two basic steps. First, an update add can be to a temporary location; while reserving resources for the destination location; or an update can be an unbalanced one without requiring modification (or moves) of previous entries. Also an update can be stored temporarily in a temporary trie structure; and updating to the regular trie database on certain events such as: end of burst of updates, controller command; or limits are exceeded such as capacity, timer.

The available chip resources for partitioning are a significant multiple of required resources for partitioning methods for a set of worse case multi-dimensional databases. The extra resources absorb the inefficiencies of fast updates, and finally eliminate the inefficiencies by the accumulated aggregation and efficiency (cost-analysis) of all updates. This multiple is called “degree of freedom” for partitioning and enables relatively easier updates and deletes in the device; and versatility to support various databases efficiently. In one embodiment, the device enables fast updates and deletes without requiring entire database to be reconstructed; and impacting only a few memory locations. Aggregation achieves packing of leaf memory resources; while differentiation or decomposition achieves high degree of path selectivity and limits required memory bandwidth to process a query.

One embodiment of a database query processor supports real world requirements for routing, security, caches and multi-dimensional databases in one device. In other embodiments, a specialized database query processor supports the real world requirements of only one or few applications. One embodiment of a database query processor supports security applications including string matching for anti-virus, intrusion detection applications along with routing classification and forwarding table lookups. Another embodiment of database query processor includes a pattern matching unit to perform cache lookups, compression table lookups, or encryption table lookups, and lookups of index tables of databases. In the above embodiments updates could be either dynamic and/or bulk loaded.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The invention has other advantages and features which will be more readily apparent from the following detailed description of the invention and the appended claims, when taken in conjunction with the accompanying drawings, in which:

FIG. 1 illustrates the basic architecture of the database query processor (DQP).

FIG. 2 illustrates a prior art pseudo-content addressable memory (pseudo-CAM) using hash memory content addressable memory (CAM) and overflow CAM controller.

FIG. 3 illustrates another prior art hash CAM Architecture.

FIG. 4 illustrates an embodiment of mapping function logic used in a DQP.

FIG. 5 illustrates an embodiment of compare function logic used in a DQP.

FIG. 6 illustrates an embodiment of comparand select logic used in a tertiary content addressable memory (TCAM) array of DQP.

FIG. 7a illustrates an embodiment of a data structure of the memory mapping in a DQP.

FIG. 7b illustrates an embodiment of a data structure of the memory leaf in a DQP.

FIG. 7c illustrates an embodiment of data structure of an IPV4 Flow entry stored in the memory leaf.

FIG. 8a illustrates an embodiment of data structure of an IPV4 Destination Lookup entry in the memory leaf.

FIG. 8b illustrates an embodiment of data structure of an MPLS Lookup entry in the memory leaf.

FIG. 8c illustrates an embodiment of data structure of an IPV4 virtual routing and forwarding (VRF) lookup entry in the memory leaf.

FIG. 8d illustrates an embodiment of data structure of a VPN deaggregation lookup entry in the memory leaf.

FIG. 8e illustrates an embodiment of data structure of a 5 tuple classification entry in the memory leaf.

FIG. 9 illustrates an embodiment of architecture of a DQP.

FIG. 10a illustrates an embodiment of a list of IPV4 entries which are mapped to last mapping stage.

FIG. 10b illustrates an embodiment of the value bitmap definition for a entry list, e.g., IPV4, while illustrating how a crossproduct bitmap is defined.

FIG. 10c illustrates the reverse bitmap function showing trie traversal to memory leaf using crossproduct bitmap, e.g., as shown in FIG. 10b.

FIG. 11a illustrates a list of IPV4 Classification entries which are mapped to a last mapping stage.

FIG. 11b illustrates an embodiment of the value bitmap definition for the entry list in, e.g., FIG. 11a, and an embodiment for defining a crossproduct bitmap.

FIG. 11c illustrates the reverse bitmap function showing trie traversal to memory leaf using crossproduct bitmap, e.g., as illustrated in FIG. 11b.

FIG. 12a illustrates a list of IPV6 Classification entries which are mapped to last mapping stage.

FIG. 12b illustrates an embodiment of the value bitmap definition for the entry list in FIG. 12a, including an example embodiment of defining a crossproduct bitmap.

FIG. 12c illustrates reverse bitmap function showing trie traversal to memory leaf using crossproduct bitmap, e.g., as illustrated in FIG. 12b.

FIG. 13 illustrates an embodiment of architecture of a 4 stage DQP.

FIG. 14 illustrates an embodiment of architecture of a 4 stage string DQP for various pattern matching applications.

FIG. 15 illustrates one embodiment of a process flow of a method for building a database tree while adding an entry to a database, for example, as applied to a 4 stage database tree, e.g., as illustrated in FIG. 14.

FIG. 16 illustrates one embodiment of a process flow of a method for evaluating the cost of an update and finding of nearest paths while adding an entry to a database.

FIG. 17 illustrates one embodiment of a process flow of a method for evaluating the cost of an update and finding of nearest paths while adding an entry to a database which can store multiple entries to leaf memory row.

FIG. 18 illustrates one embodiment of a process flow of a method merging and restructuring a database tree while deleting an entry to a database.

FIG. 19a illustrates one embodiment of a database tree, including, for example, an embodiment in which a first major branch is at Tag1 which one of n children of the root node.

FIG. 19b illustrates one embodiment of how the above database with overlapping regions (wildcards) and selectively dense paths could be mapped to an embodiment of the database query processor (DQP).

FIG. 20 illustrates one embodiment of a system for the DQP query pipeline, for example, through a DQP of FIG. 13 and further by way of example in FIG. 20, which shows an example of data transfer and control transfer to select likely paths to perform a query.

FIG. 21 illustrates one embodiment of a system for the DQP update path allocation pipeline, for example, through the DQP of FIG. 13, and also illustrates an example of data transfer and control transfer to select likely paths to perform an update while picking the lowest cost resource and keeping memory bandwidth below programmed limit.

FIG. 22 illustrates one embodiment of a system for the DQP update write pipeline, for example, through the DQP of FIG. 13, and also illustrates an example of memory write operations to tag, stem map, and other maps, and leaf memory resources.

FIG. 23 illustrates one embodiment of a method for a sequence of pipelined DQP query, update add (update path allocate), and update write operations, including an embodiment of how the device can achieve high pipelined query and update performance.

FIG. 24 illustrates one embodiment of a system for the DQP string query pipeline, for example, through the DQP of FIG. 14, and also illustrates an example of a query for the string “PERL.EXE.”

FIG. 25 illustrates an embodiment of a system for the DQP query pipeline, for example, through the DQP of FIG. 13, and also illustrates an example of a query for an IP address “128.0.11.1.”

FIG. 26 illustrates an embodiment of a system for the DQP string query pipeline and an UTM (Unified Threat Management) application.

FIG. 27 illustrates an embodiment of a system for the DQP query pipeline and a database acceleration application, for example, through the DQP of FIG. 14.

FIG. 28 illustrates an embodiment of a system for the DQP string query pipeline for a cache and data mining application including dictionary and weblinks, for example, through the DQP of FIG. 14.

FIG. 29 illustrates an embodiment of a system with a CPU (central processing unit) and DQP storing the lookup tables and database memory, for example, through the DQP of FIG. 14.

FIG. 30 illustrates an embodiment of a system pipeline with a CPU and DQP storing the lookup tables and database memory, for example, through the figure of the DQP of FIG. 14.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Overview

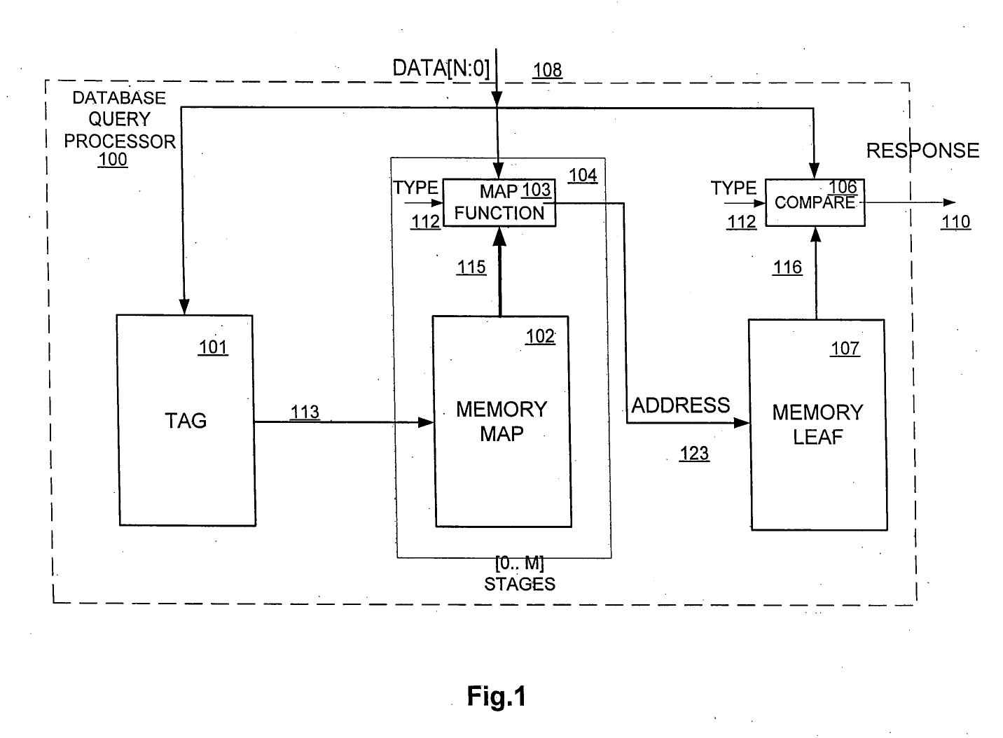

FIG. 1 illustrates the basic architecture of the database query processor (DQP) 100. The DQP 100 includes a tag Block 101, and a memory map block 102, a map function block 103, memory leaf block 107, and a compare function block 106. The (DQP) 100 distributes the incoming data over data distribution bus 108, to the tag block 101, the memory map block 102, and the memory leaf block 107. The compare function compares the entries read from the memory leaf with the incoming data on data bus 108; and organizes the results in format required by user and sends out the response 110 containing one or many sets of match flag, associated address, flags and associated data.

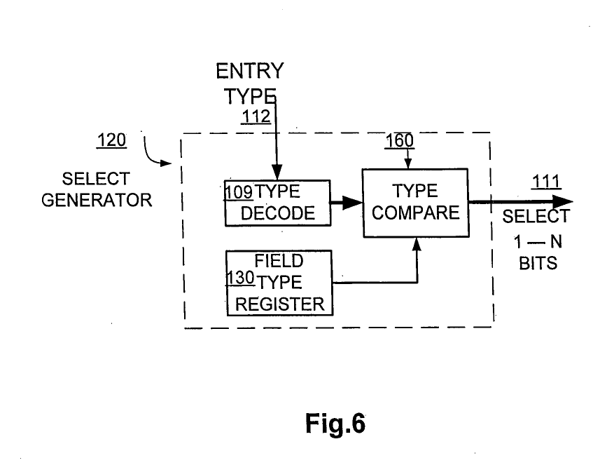

The tag block 101 consists of traditional CAM array selector and comparand assembly functions, and binary CAM or TCAM (ternary content addressable memory) array. The selector function (see FIG. 6) selects sections of data word based on the instruction (on bus 204) information defining type of query data or update data record. The selected sections are assembled together to form the comparand word and compared with the stored elements in the array.

Conventional approaches described in Schaffer's Thesis show CAM (content addressable memory) organization and configurable word width. CAM (content addressable memory) and TCAM (ternary content addressable memory) ASICs (Application Specific Integrated Circuits) with functions described above are sold by Sibercore, IDT, Cypress, and NetLogic Microsystems. Dolphin Technology and Virage Logic also develop CAM and TCAM macros. The tag array 101 includes memory read and write circuits; comparator drivers and array of CAM cells coupled together on match lines (for a wired or XOR function) to compare stored words against comparand words which are distributed over compare lines. To achieve variable CAM search word size, configuration combination logic combines CAM sub-word segments in the array, and a priority encoder generates the resulting highest match index 113. Configuration combination logic is described in Schaffer's Thesis. (See, e.g., J. H. Schaffer, “Designing Very Large Content-Addressable Memories,” Written Preliminary Exam, Part II, Distributed System Lab., CIS Dept., University of Pennsylvania, Dec. 5, 1992, pp. 1-23). The relevant content of schaffer's Thesis is herein incorporated by reference.

Each mapping block 104 consists of a memory map function 103, and a memory map 102. The memory map is a memory storage array that stores the trie information. During a query or update (add/delete) operation the root node is identified in the tag block array 101; which generates the identified index 113 and is used to access memory map 102. The data read 115 from the memory map 102 includes statistics needed to perform update (add/delete) operations; and trie path information to successively identify through zero to m stages of mapping blocks 104; the eventual leaf block(s) including memory leaf 107. The DQP 100 receives the search type information 112 and field types during any query or update operation.

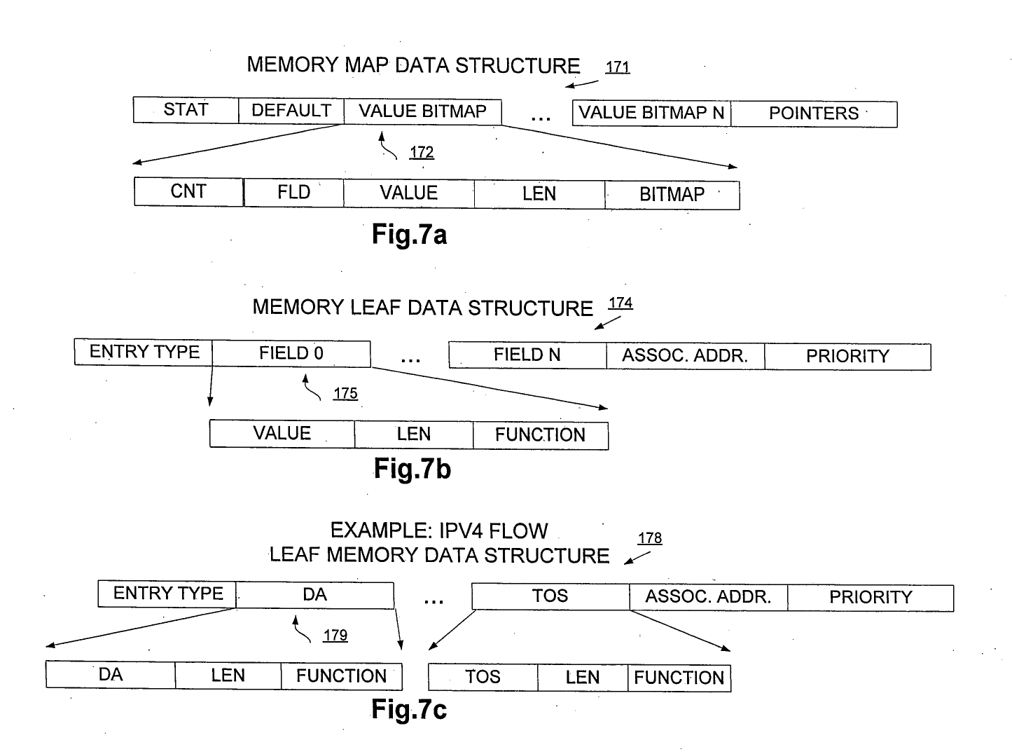

The mapping function 103 compares the stored trie values with incoming distributed data bus 108 and processes value bitmap to find valid pointer paths. Each mapping block 104 can point to a default path; and/or a specific path. The bitmap information can be used to select i) a more specific path and a default or aggregated path or ii) either a specific path or a default path. The crossproduct function of value bitmap (e.g., FIG. 7a) selects a specific and/or a default or aggregated path.

FIG. 10a shows a Table with memory map organization of value bitmap fields with its constituents FLD: Field Type, VALUE: actual value, LEN: length of field, and a bitmap indicating valid paths. To enable a flexible trie path information for varying tree structure certain functions are built in. When multiple fields point to the same path; then a product of the fields is used to select such a path. FIG. 10a and FIG. 10b show that path1 is active when Value1 and Value2 are valid.

The fields Value1 and Value2 are of Field Type “Field 1”; while Value3 is of Field Type “Field 2.” The field Value1 point to path1. The field of Value2 points to 2 paths: path1 and path2. In this case the field Value3 (of type field 2) can be a child of only Value2. Using explicit or implicit indicators, we may map the value field Value3 to be a child of Value2.

When a field type has multiple values and at multiple value fields point to the same path; then AND terms are separated out considering only valid term combinations. FIG. 10c illustrates the AND products for each path; as a set of valid AND products are evaluated from the value bitmap fields.

The reverse bitmap function in FIG. 10c is generated based on the stored trie information in memory map. The STAT field for statistics and CNT field for count information is used during update (add/delete) to use integrated device DQP 100 resources efficiently. Each path is associated with a pointer to access the next stage of trie traversal and can be either the next stage of mapping block 104 or leaf block 107. The address(es) generated by mapping block 104 are shown by the address bus 113 and coupled to the next stage which can be either a mapping block 104 or leaf block 107.

For a query instruction the address 113 for given trie path is provided by the last mapping block 104. The address 113 is used to access the memory leaf 107, and the data is read out on bus 116; the data is organized in the format described in FIG. 7b. An entry or record is defined by an entry type, and values and lengths of each field are stored; and finally an associated address (not necessary if implicit stored address is used) and priority value is used.

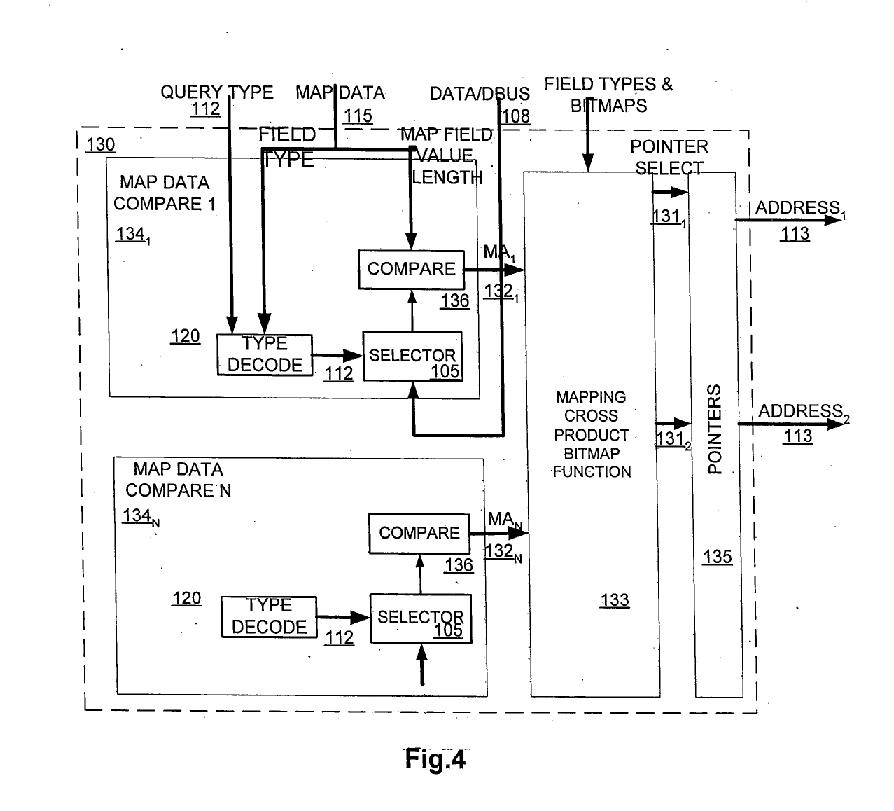

FIG. 4 illustrates an embodiment of mapping function logic used in DQP. The map data compare units 1341,N receive the query type information 112; this determines the organization of fields on the incoming data bus 108. Each map data compare unit 1341,N includes type decode block 120, selector 105, and a compare block 136. The map data 115 read out from the memory map includes field type, field value, field length and other information (see FIG. 7a).

In the type decode block 120 map data's field type information is compared with the incoming query type to determine which part of the incoming data bus is relevant to the comparison with map data's 115 field value. The appropriate data bus' 108 field is selected using well known multiplexers or and logic in the selector block 105. The selected field (from data bus 108) is compared with the map data's (115) field value; while using map data's (115) field length to perform a ternary comparison in the compare block 136 (e.g., don't care for bits that are beyond valid length). The result is a match signal 1321,N for each field with value in map data 115.

The array of matching signals 1321,N is coupled with the mapping function's crossproduct bitmap function 133. The crossproduct bitmap receives an array of matching signals 1321,N for each of its value fields. The crossproduct bitmap function also receives the field types, and precedence information for each valid trie entry or record, and the bitmaps of each value field. Each bitmap defines whether a route is included when the associated value is matched. See FIG. 10b as an example for a mapping of a list of entries (as in, e.g., FIG. 10a) to a set of value bitmaps and to the result of crossproduct bitmap processed results (as in, e.g., FIG. 10c).

FIG. 10c shows the expected combination of match signals 1321,N coupled to the crossproduct bitmap function. In summary, the crossproduct bitmap performs the transformation of bitmap values, and field types to expected matches in the map data's compare units. If the incoming match signals correspond to the crossproduct then the associated path(s) is (are) selected with the pointer select signals 1311,2. The associated paths are stored as pointers 135, the pointer select signals 1311,2 select relevant pointers and use as addresses 113 to access the next stage of the trie in the next memory map stage or in the memory leaf stage. In this embodiment only 2 possible paths are shown, though the maximum number of paths can be more.

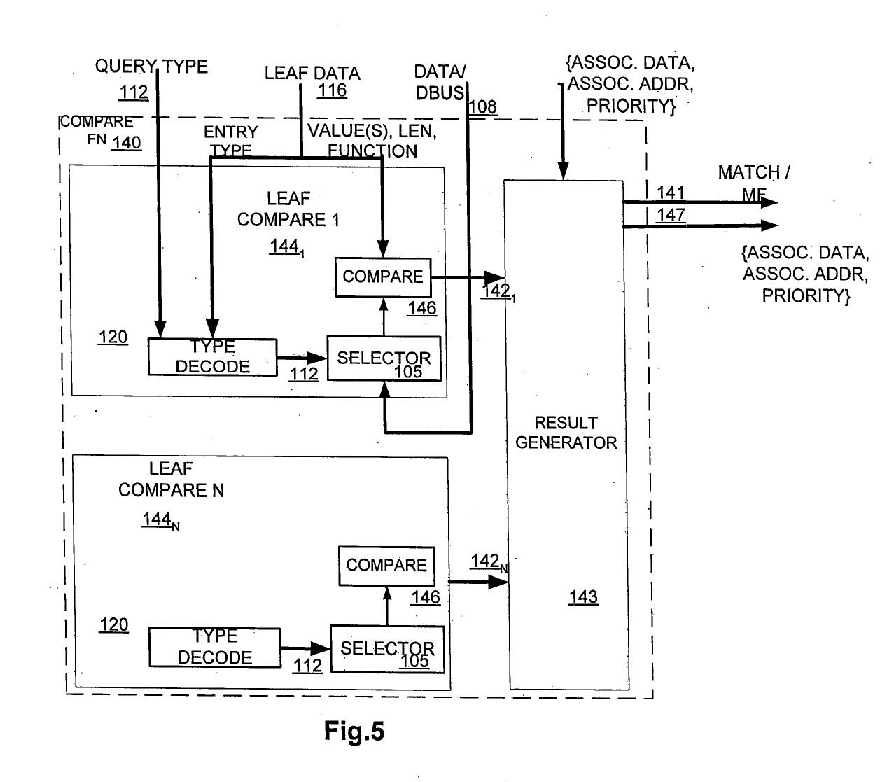

FIG. 5 illustrates an embodiment of compare function logic used in a DQP. The memory leaf data compare units 1441,N receives the query type information 112; this determines the organization of fields on the incoming data bus 108. Each map data compare unit 1441,N includes type decode block 120, selector 105, and the compare block 146. The leaf data 116 read out from the memory leaf includes entry type, and entry fields (with value, field length and function), and information associated with the entry (such as associated data address, priority, and associated data) as is also described in FIG. 7b. In the type decode block 120, leaf data's field type information is compared with the incoming query type to determine which part of the incoming data bus is relevant to the comparison with leaf data's 116 field value. The appropriate data bus' 108 field is selected using well known multiplexers or and logic in the selector block 105. The selected field (from data bus 108) is compared with the leaf data's (116) field value; while using leaf data's (116) field length to perform a ternary comparison in the compare block 146 (“don't care” for bits that are beyond valid length). The result is a match signal 1421,N for each field with value in leaf data 116.

The array of matching signals 1421,N is coupled with the result generator 143. The result generator 143 receives an array of matching signals 1421,N for each of its value fields. The result generator 143 also receives valid product terms; as well as function signals for any term (see, e.g., FIG. 7b); and the associated information with the entry (associated address, priority, associated data). If the incoming match signals 1421,N correspond to the functional combination of valid terms; a match is declared and the associated information with the entry is propagated. If there are multiple entries on the same memory leaf data 116, then the best match or set of matches 141 and their associated information 147 is propagated to the output or next stage.

FIG. 6 illustrates an embodiment of comparand select logic used in the tag (including TCAM) array of DQP. This function is used to select the relevant fields in the incoming distribution data bus. The incoming query type 112 is defined by the incoming command. Each tag block is associated with certain fields of the entries. For example, in a tag block may be associated with the first 16 bits of the incoming data. Thereafter, only the first 16 bits need to be selected from the incoming data bus. This information is stored as the type register 130. The incoming query type is processed by type processing 109 to include state information. In type compare unit 160, the processed query type information is compared with the type register 130 which also holds the inputs used to select the multiplexer or selector signals 111. Similar processing is used in the memory mapping function, the only difference being the memory map data supplies only the field type information.

FIG. 7a illustrates an embodiment of data structure of the memory map in the DQP. The memory map data structure 171 includes a statistics field, an optional default memory leaf or entry path, n value bitmap fields, and pointers associated with the bitmap. The statistics field includes total count of children (entries) belonging to this memory map. The memory map can optionally store statistics to help in partitioning or tree restructuring decisions such as length at which first major tree partitioning occurs, and second partition and more for larger trees. Each value bitmap 172, stores the field identifier (FLD), an optional count of all children, value of the field (VALUE), and the length of the valid field (LEN), and the associated bitmap of valid buckets of the tree which are mapped to pointers.

FIG. 7b illustrates an embodiment of data structure of the memory leaf in the DQP. The memory leaf data structure 174, has one or many entries each constituting an entry type field, n fields 175 with value, length and function; and associated data. The associated data could consist of optional fields of associated address, priority. The n fields stored can include all the fields of the entry or in can be only relevant fields which are not stored in the preceding tag or memory map sections. This ability allows packing of more entries in the memory leaf, and this is beneficial for smaller entry sizes. Also implicit addressing (no need for storage of associated address) can be used beneficially when associated data can be stored together or when movement of associated data is not desirable. The priority field is also redundant when the entry and its valid fields and lengths of each field define a precedence, and therefore, not requiring any additional field to define precedence over other entries.

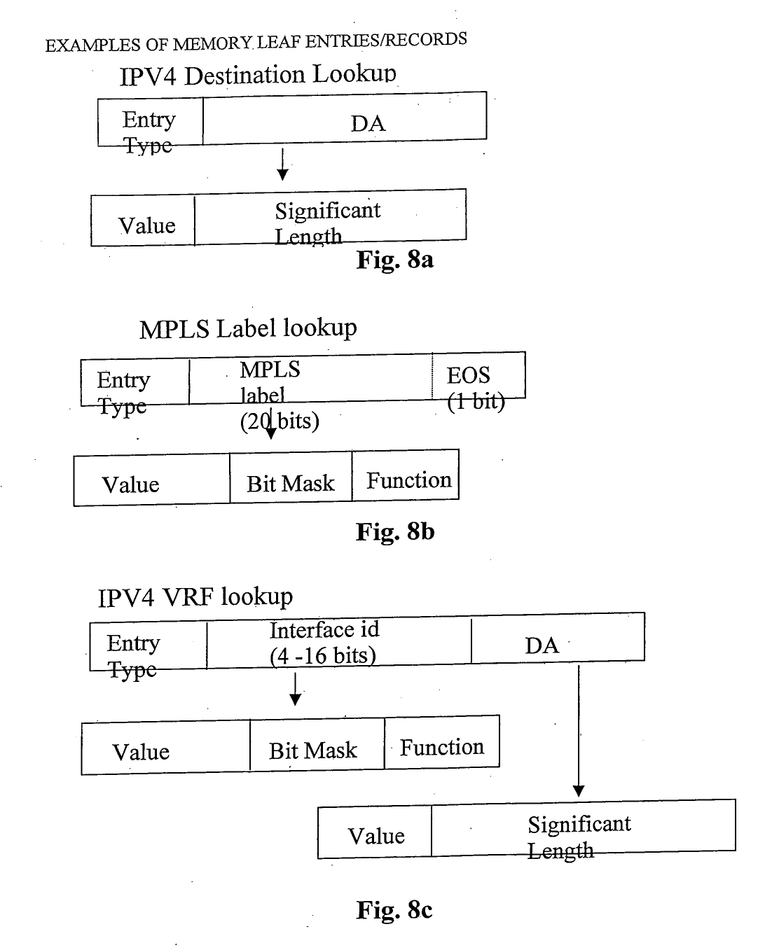

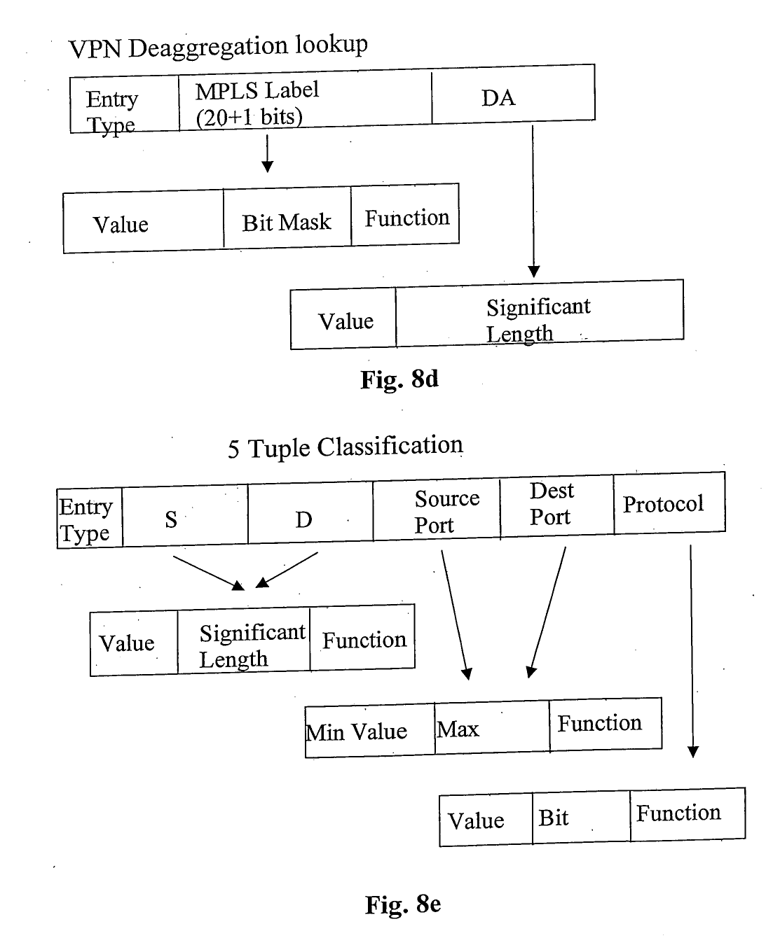

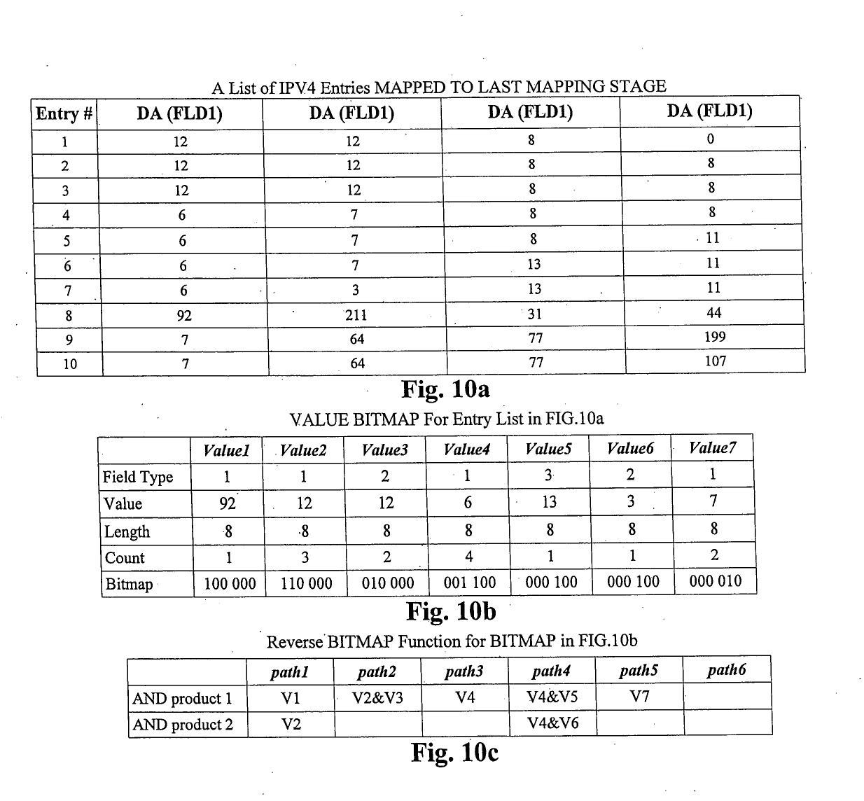

FIG. 7c illustrates an embodiment of data structure of an IPV4 Flow entry 178 stored in the memory leaf. The function defined can be a NOT or an OR function. Traditionally the terms are ANDed and that could be defined as default in one embodiment. The field DA (destination address) 179 is one of the fields of the entry 178. FIG. 8a illustrates an embodiment of data structure of an IPV4 Destination Lookup entry in the memory leaf. FIG. 8b illustrates an embodiment of data structure of an MPLS Lookup entry in the memory leaf. FIG. 8c illustrates an embodiment of data structure of an IPV4 VRF (Virtual Routing & Forwarding) Lookup entry in the memory leaf. FIG. 8d illustrates an embodiment of data structure of VPN Deaggregation Lookup entry in the memory leaf. FIG. 8e illustrates an embodiment of data structure of a 5 Tuple Classification entry in the memory leaf.

First Example Embodiment

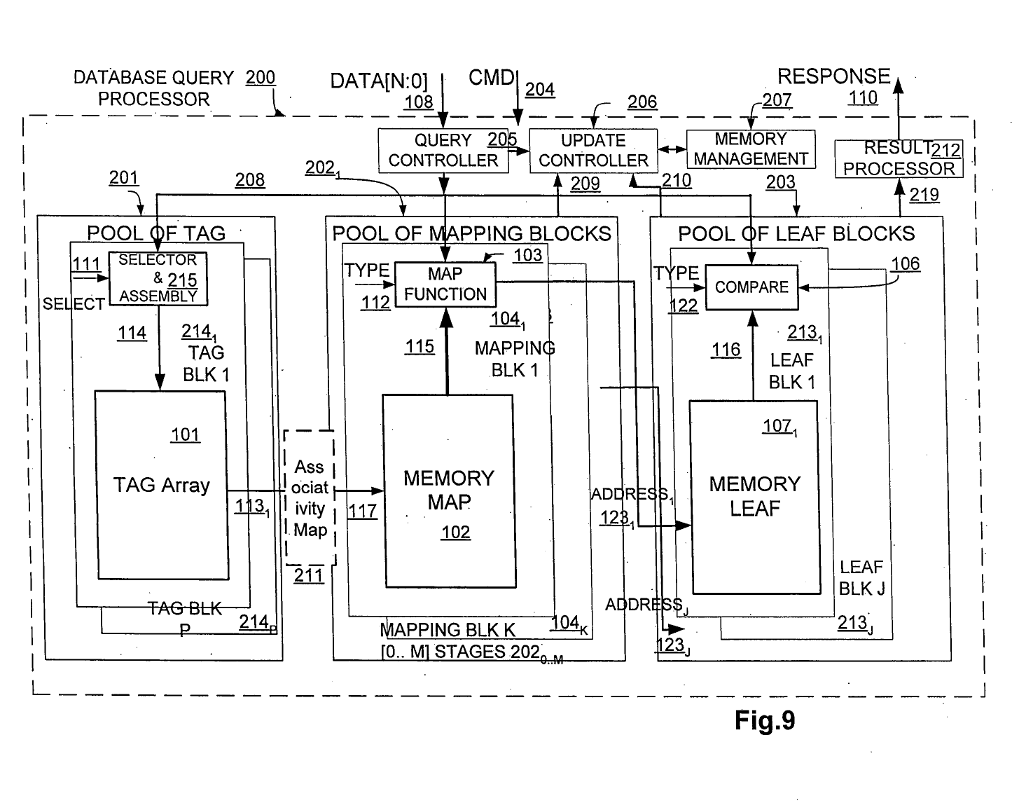

FIG. 9 illustrates a preferred embodiment of a Database Query Processor (DQP) 200 in accordance with the present invention. The DQP 200 includes a pool of tag blocks 201, a pool of mapping blocks 202, a pool of leaf blocks 203, a query controller 205, an update controller 206, a memory management unit 207 and an associativity map unit 211. The query controller 205 is coupled to receive instructions over CMD bus 204 from a host device (e.g., general purpose processor, network processor, application specific integrated circuit (ASIC) or any other instruction issuing device).

The query controller 205 also receives the data bus 108; and controls operations of data path blocks (which store and process data): the pool of tag blocks 201, the pool of mapping blocks 202, the pool of leaf blocks 203, and the result processor 212; and the control units: the update controller 206, the memory management unit 207, and the associativity map unit 211. The query processor 205 distributes the incoming data over data distribution bus 208, to the pool of tag blocks 201, the pool of mapping blocks 202, and the pool of leaf blocks 203, and the update controller 206.

The update controller 206 receives results from the pool of mapping blocks 202 and pool of leaf blocks 203. The memory management unit 207 allocates storage location and paths for updates or restructured trie paths or reorganizes free lists when entries are deleted or trie paths are restructured.

The memory management unit 207 transfers to the update controller 206 locations of partial or unallocated memory rows; so that update controller 206 selects the lowest cost storage path. When memory rows become unallocated or partial the update controller 206 informs the memory management unit 207 which updates its partial and unallocated free lists. The result processor 212 receives results from any compare function unit 106 of each leaf block 213; and also from any of the memory mapping block(s) 104. The result processor 212 organizes the results in format required by user and sends out the response 110 containing one or many sets of match flag, associated address, flags and associated data.

Each tag block 2141,P consists of selector and assembly unit 215, and a CAM array (including BCAM (binary content addressable memory) or TCAM (ternary content addressable memory) array 101. The selector function (see, e.g., FIG. 6) selects sections of data word based on the instruction (on bus 204) information defining type of query data or update data record. The selected sections are assembled together to form the comparand word and compare with the stored elements in the array.

Conventional systems that are described in Schaffer's Thesis show CAM (content addressable memory) organization and configurable word width. The TCAM array 101 includes memory read and write circuits; comparator drivers and array of CAM cells coupled together on match lines (for a wired or XOR function) to compare stored words against comparand words which are distributed over compare lines. TCAM (ternary content addressable memory) ASICs (Application Specific Integrated Circuits) with functions described above are sold by Sibercore, IDT, Cypress, and NetLogic Microsystems. Dolphin Technology and Virage Logic also develop TCAM macros. Basic TCAM arrays include comparand registers, compare drivers and array of CAM cells. To achieve variable CAM search word size, configuration combination logic combines CAM sub-word segments in the array, and a priority encoder generates the resulting highest match index 113. Conventional configuration combination logic is described in Schaffer's Thesis.

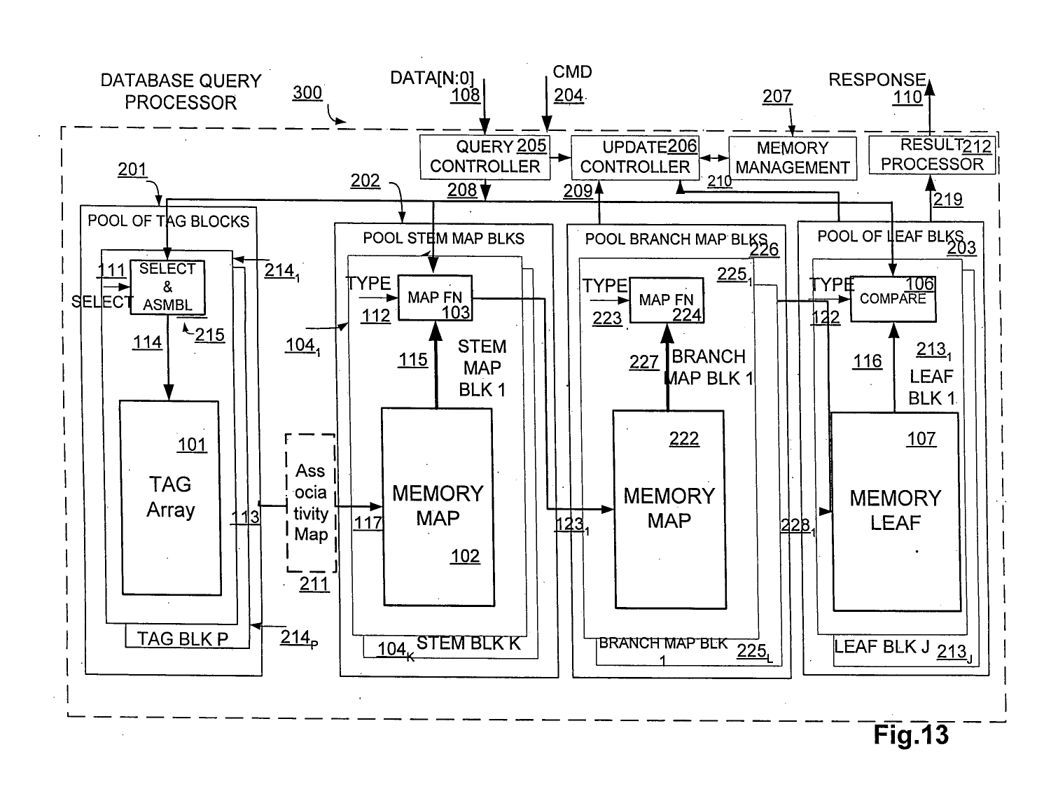

The associativity map unit 211, e.g., as illustrated in FIG. 9 and FIG. 13, is used to efficiently map the variable width, configurable TCAM arrays 101 to mapping blocks memory map units 102. It is also desirable to use repeated instances of TCAM arrays for tag block and repeated arrays of memory map for mapping storage to achieve ease of design and use redundancy of blocks to improve yields. The associativity map unit 211 maps the varying index 113 (address space) to the memory map units 102. The input to the associativity map is 113 from each tag array 101; and the output 117 is used to address the mapping memory map units 102.

Each mapping block 1041,K consists of a memory map function 103, and a memory map 102. The memory map is a memory storage array that stores the trie information. During a query or update (add/delete) operation the root node is identified in the tag block array 101; which generates the identified index 113; which is then mapped to address 117 and used to access memory map 102. The data read 115 from the memory map 102 includes statistics needed to perform update (add/delete) operations; and trie path information to successively identify through zero to m stages of mapping stages 202_{0,M}; the eventual leaf block(s) 213_{1,J} including memory leaf 107.

The mapping functions 103 identifies the valid entry types 112 and field types during any query or update operation. Each memory map field in the memory map data 115 identifies a field type. FIG. 7a shows an embodiment of the memory map data structure highlighting the value bitmap data structure constituted of CNT indicating count of total entries associated with a field; FLD indicating the field type, the VALUE field indicating actual value of for this trie path, and LEN indicates valid length; with remaining bits masked, and bitmap is a bitmap of applicable valid pointers or trie paths. The mapping function 103 compares the stored trie value with incoming distributed data bus 208, processes bitmap to find valid pointer paths. The TYPE information from the query controller 205 along with FLD: field type information from memory map is used to select the relevant fields from incoming distributed data bus 208.

Each mapping block 104_{1,K} can point to a default path; or a specific path. The bitmap information can be used to select i) a more specific path and a default path or ii) either a specific path or a default path. The former is used when aggregated paths or default paths are pointed by crossproduct function of n value bitmap fields (e.g., FIG. 7a) and the latter is used when more specific routes are identified by value bitmap fields. For example, FIG. 10 shows a Table with memory map organization of value bitmap fields with its constituents FLD: Field Type, VALUE: actual value, LEN: length of field, and a bitmap indicating valid paths. To enable a flexible trie path traversal for varying tree structure certain functions are built in. When multiple fields point to the same path; then a product of the fields is used to select such a path. FIG. 10a and FIG. 10b are examples that show path1 is active when Value1 or Value2 is valid.

The fields Value1 and Value2 are of Field Type “Field 1”; while Value3 is of Field Type “Field 2.” The field Value1 point to path1. The field of Value2 points to 2 paths: path1 and path2. In this case the field Value3 (of type field 2) can be a child of only Value2. Using explicit or implicit indicators, we may map the value field Value3 to be a child of Value2.

When a field type has multiple values and at multiple value fields point to the same path; then AND terms are separated out considering only valid term combinations. FIG. 10c illustrates the AND products for each path; as a set of valid AND products are evaluated from the value bitmap fields.

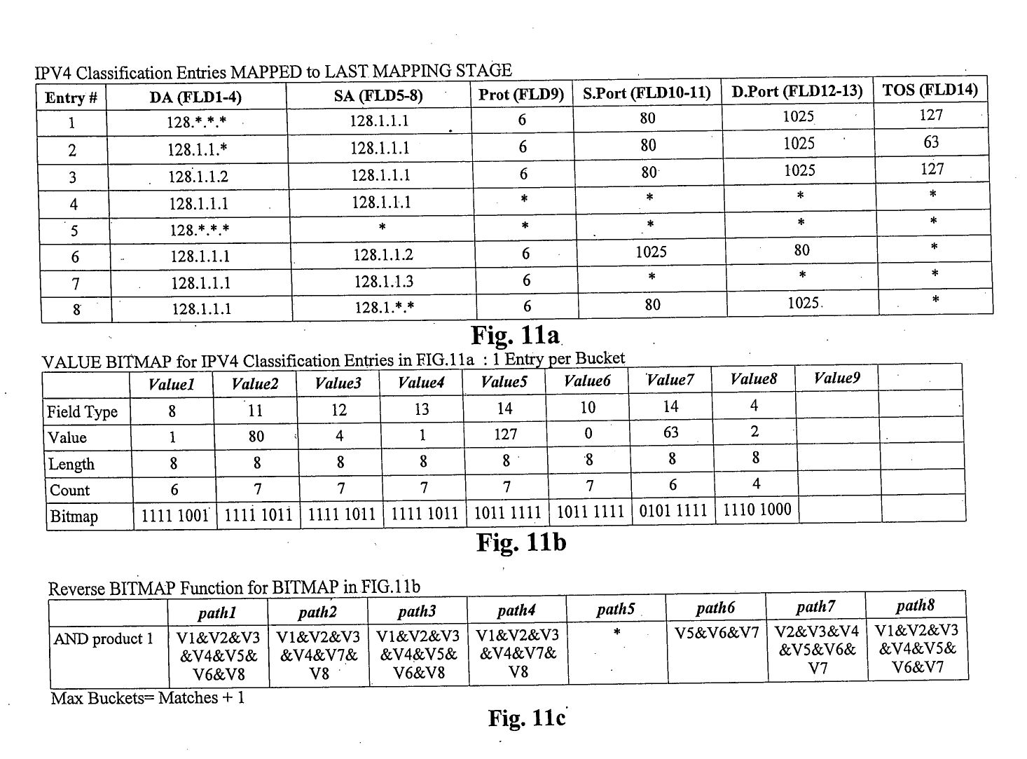

The reverse bitmap Function illustrated in FIG. 11 is generated based on the stored trie information in memory map. The STAT field for statistics and CNT field for count information is used during update (add/delete) to use integrated device DQP 200 resources efficiently. Each path is associated with a pointer to access the next stage of trie traversal and can be either the next stage of mapping block 104_{1,K} or 213_{1,J}. The address(es) generated by mapping block 104_{1,K} are coupled by the address bus 123_{1,K} and coupled to the next stage which can be either a mapping block 104_{1,K} or leaf block 213_{1,J}.

The pool of leaf blocks 203 consists of a set of leaf blocks 213_{1,J}. Each leaf block is constituted of a memory leaf 107 and compare function unit 106. For a query instruction the address 123 for given trie path is provided by the last mapping block 104; when 1 or more mapping stages are present; or by the Tag Array 101 when no mapping stage is used. The address 123 is used to access the memory leaf 107, and the data is read out on bus 116. In one embodiment, the data is organized in the format described in FIG. 7b. An entry or record is defined by an entry type, and values and lengths of each field are stored; and finally an associated address (not necessary if implicit stored address is used) and priority value is used. Using a priority value enables storage of record or entry without need to move data to reorder the entries. McAuley describes the conventional concept of priority on page 8 of “Fast Routing Table Lookup Using CAMs” at Infocom 1993.

Examples of data structures in accordance with the present invention are described in FIG. 7 and FIG. 8. Enrica Filippiet al's, “Address lookup solutions for Gigabit Switch/Router”, describes basic conventional structures for masking value fields and the relevant contents are herein incorporated by reference.

FIG. 10a illustrates a list of IPV4 entries which are mapped to the last mapping stage. FIG. 10b illustrates an embodiment of memory map's data structure's value bitmap fields for the entry list in FIG. 10a. Each bit in the bitmap is associated with a path pointed by pointer. For example for Value1 the field type is 1, the value is 92, and length is 8, the optional count of 1 shows number of entries that belong to Value1 field. The bitmap is set for the first bit, meaning that the first pointer is the only possible path for an entry that belongs to Value1.

FIG. 10c illustrates the reverse bitmap function showing trie traversal to memory leaf using crossproduct bitmap from FIG. 10b. The table shows how a crossproduct function is derived from processing the memory map data including the value bitmap fields. A crossproduct function is defined for each path which is associated with a pointer.

Path1 is Valid when Value1 (field1) is matched. Value2 however points to the first 2 bits in bitmap and hence belongs to a different path. Value2 (also field1) maps to first bit of bitmap along with Value1 so as to aggregate and pack memory leaf storage. Value2 when ANDed (product) with Value3 (field2) differentiates the tree into a different storage path2. As seen in the AND products for each path a set of valid AND products are evaluated from the value bitmap fields. In one embodiment the children of lower value fields that are a subset of higher fields are also assumed to belong to the higher fields; and in the reverse bitmap function this assumption is used. In this case the Value6 (field2) has the value equal to 3 with length of 2 only (thus including both 3, 7). In another embodiment, such an assumption made only if explicitly indicated by a control bit. Here, a crossproduct includes values of higher fields which are supersets, and not those of higher fields of equal sets as shown in the example in FIG. 10b where Value5 is a child of Value4 (field1) which is a superset and not a child of equal set Value6 (field2). FIG. 11a illustrates a list of IPV4 Classification entries which are mapped to the last mapping stage.

FIG. 11b illustrates an embodiment of memory map's data structure's value bitmap fields for the entry list in FIG. 11a. Each bit in the bitmap is associated with a path pointed by pointer. For example, for Value1 the field type is 8, the value is 1, and length is 8, the optional count of 6 shows number of entries that belong to Value1 field. The bitmap is set for six of eight bits, meaning that entries that belongs to Value1 can have any of 6 possible pointer paths. This is a special case showing overlapping regions of a multi-dimensional database.

FIG. 11c illustrates the reverse bitmap function showing trie traversal to memory leaf using crossproduct bitmap from FIG. 11b. The reverse mapping function uses all fields that map to path1 as terms for a set of AND terms. For a specific path, if 2 or more value fields belong to same field, than each would belong a separate AND product. In this example all the value fields that map to path1 are different, hence a single AND product.

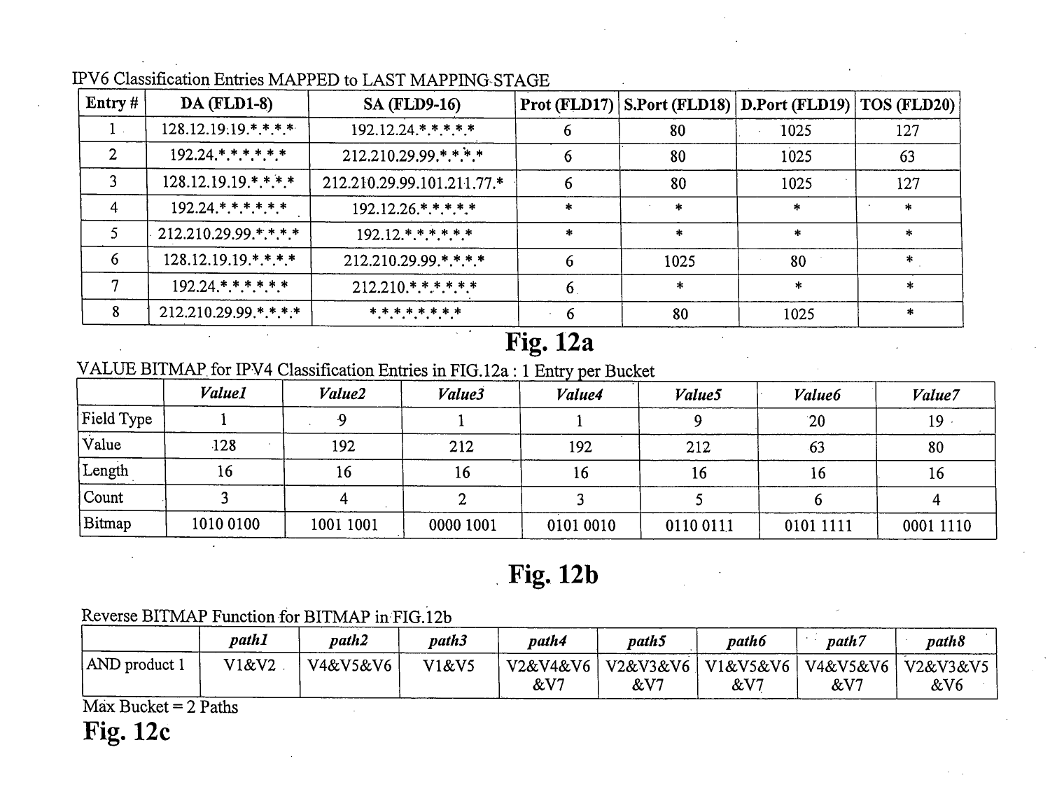

FIG. 12a illustrates a list of IPV6 Classification entries which are mapped to the last mapping stage.

FIG. 12b illustrates an embodiment of memory map's data structure's value bitmap fields for the entry list in FIG. 12a. Each bit in the bitmap is associated with a path pointed by pointer. For example for Value1 the field type is 1, the value is 128, and length is 16, the optional count of 3 shows number of entries that belong to Value1 field. The bitmap is set for three of the eight bits, meaning that entries that belongs to Value1 can have any of 3 possible pointer paths. This is a special case showing overlapping regions of a multi-dimensional database.

FIG. 12c illustrates the reverse bitmap function showing trie traversal to memory leaf using crossproduct bitmap from FIG. 12b. The reverse mapping function uses all fields that map to path1 as terms for a set of AND terms. For a specific path, if 2 or more value fields belong to same field, than each would belong a separate AND product. In this example all the value fields that map to path1 are different, hence a single AND product.

FIG. 13 illustrates an embodiment of architecture of a 4 stage DQP 300. The DQP 300 includes a pool of tag blocks 201, a pool of first or stem mapping blocks 202, a pool of second or branch mapping blocks 226, a pool of leaf blocks 203, a query controller 205, an update controller 206, a memory management unit 207 and an associativity map unit 211. The query controller 205 is coupled to receive instructions over CMD bus 204 from a host device (e.g., general purpose processor, network processor, application specific integrated circuit (ASIC) or any other instruction issuing device).

The query processor (or controller) 205 also receives the data bus 108; and controls operations of data path blocks (which store and process data): the pool of tag blocks 201, the pool of first or stem mapping blocks 202, the pool of second or branch mapping blocks 226, the pool of leaf blocks 203, and the result processor 212; and the control units: the update controller 206, the memory management unit 207, and the associativity map unit 211. The query processor 205 distributes the incoming data over data distribution bus 208, to the pool of tag blocks 201, the pool of first or stem mapping blocks 202, the pool of second or branch mapping blocks 226, and the pool of leaf blocks 203, and the update controller 206.

The update controller 206 receives results from the pool of first or stem mapping blocks 202, the pool of second or branch mapping blocks 226, and pool of leaf blocks 203. The memory management unit 207 allocates storage location and paths for updates or restructured trie paths or reorganizes free lists when entries are deleted or trie paths are restructured. The memory management unit 207 transfers to the update controller 206 locations of partial or unallocated memory rows; so that update controller 206 selects the lowest cost storage path.

When memory rows become unallocated or partial the update controller 206 informs the memory management unit 207 which updates its partial and unallocated free lists. The result processor 212 receives results from each compare function unit 106 of each leaf block 2131,J (J blocks); and also from any of the memory mapping block(s) 1041,K and 2251,L. The result processor 212 organizes the results in format required by user and send out the response 110 containing one or many sets of match flag, associated address, flags and associated data.

The memory management unit 207 allocates paths to store new entries. At any stage of the trie traversal from tag-->map1 (stem map)-->map2 (branch map)-->leaf memory; many traversal paths (typically 2-4 paths) are available at each stage. The cost calculation in the path allocation attempts to pack leaf memory; and reduce memory bandwidth. The newly allocated path is such that it uses available memory bandwidth resources so that a deterministic (e.g., fixed latency) query is performed.

The description of tag block array 214, and the associativity map unit 211 is the same as in FIG. 9. The pool of first or stem mapping blocks 202 is constituted of stem mapping blocks 1041,K and the description of stem mapping block 104 is the same as for FIG. 9. The pool of second or branch mapping blocks 226 is constituted of branch mapping blocks 2251,I and description of the branch mapping block 225 is similar to that of the mapping block 102 in FIG. 9. The corresponding elements between first or stem mapping block 104 and the pool of second or branch mapping blocks 226 as far as the description (not necessarily the exact same functionality) in FIG. 9 are: type 112 is equivalent to type 223, mapping function 103 is equivalent to mapping function 224, memory map 102 is equivalent to 222, and the address signal 123 is equivalent to address signal 228. And finally the description of the pool of leaf blocks 203 is the same as described for the pool of leaf blocks 203 in FIG. 9.

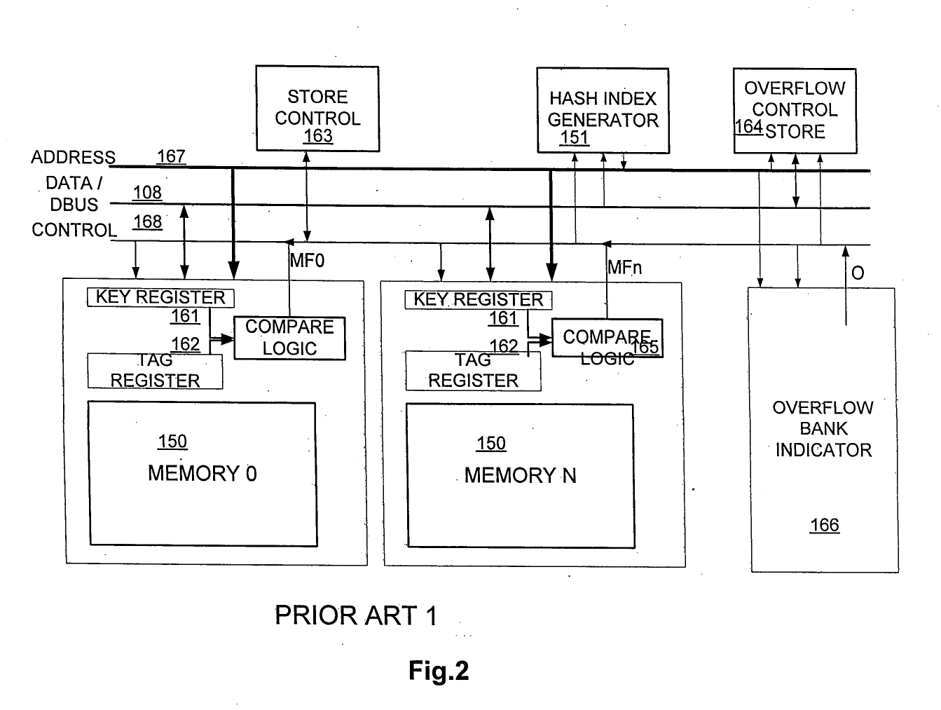

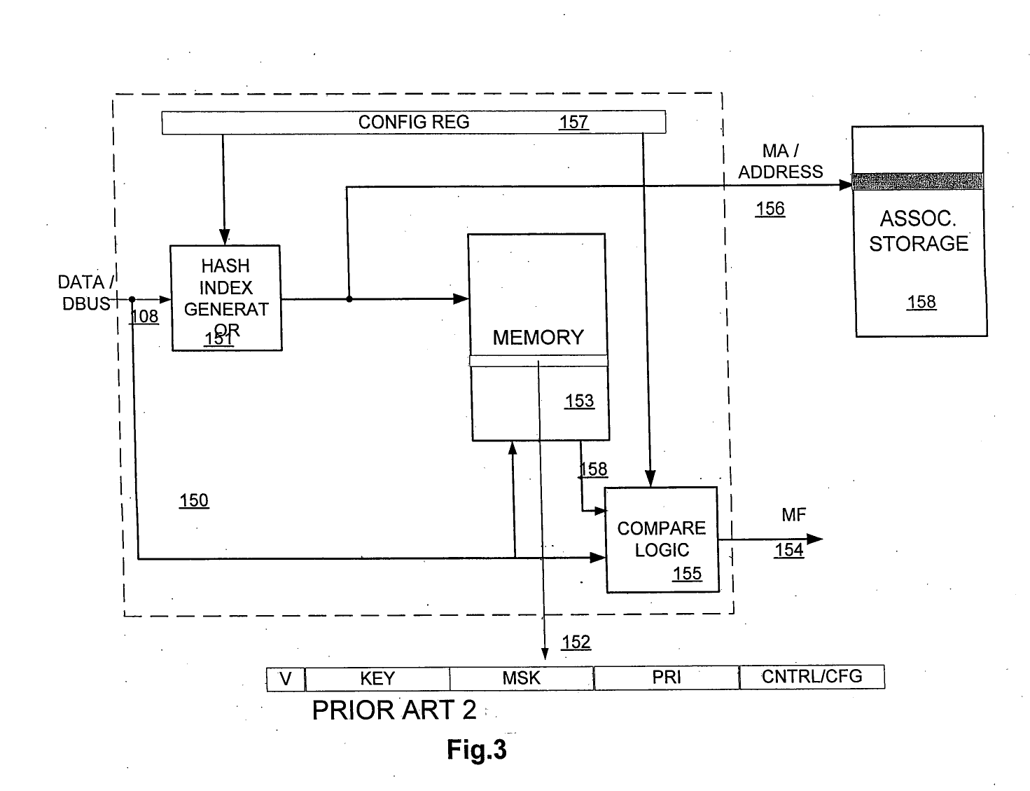

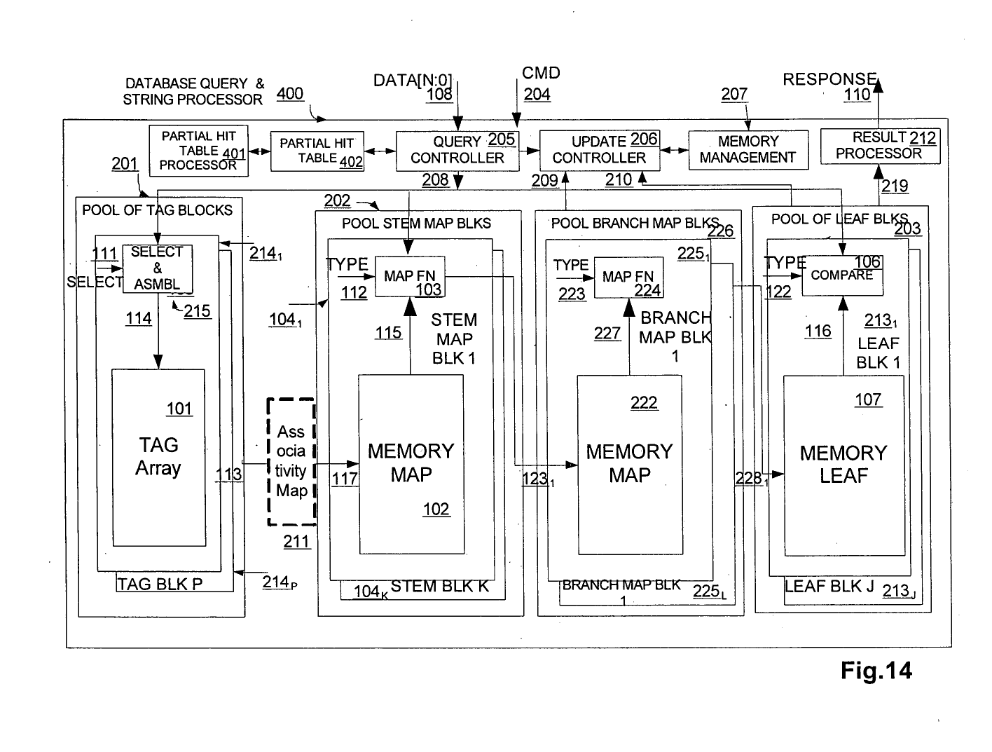

FIG. 14 illustrates an embodiment of architecture of a 4 stage string DQP 400 for various pattern matching applications including anti-virus and intrusion detection security applications, as well as other applications, e.g., text search, data mining, and bio-informatics database applications. In one embodiment, the DQP 400 supports security applications for anti-virus, and intrusion detection and also for text searching and data mining. The DQP for strings can be applied to all string based applications. The DQP 400 includes the DQP 300 in FIG. 13 and 2 blocks unique to string processing: the partial hit table 402, and the partial hit table processor 401.

When an incoming string on databus 208 is compared with the stored tries a small set of possible string entries are selected. Since final resolution of string based content entries may need to await a final test after 50 to 100 characters in one example and more in some other cases; the selected entries are stored in a partial hit table 402 and the state of matching fields, and fields that need to be matched along with information such time out, offsets, and distances between individual strings within a string based content rule or alternatively grammar descriptions are stored in the partial hit table 402. The partial hit table processor 401 uses the state information in the partial hit table 402, matches unresolved string fields with incoming data to identify a matching entry. For strings that are longer than the longest search word (typically 40 to 160 byte long) supported in the DQP array; the partial hit table is used to store significant sections of these strings. The partial hit table and the partial hit processor together perform string (sections) loading, string comparison, string elimination and string match identification. In one embodiment some or all of the partial hit table could reside on a processor coupled with the DQP 400.

The DQP 400 can be used to perform both anchored pattern, and unanchored pattern queries. Unanchored patterns require a query on every byte shift of the incoming stream, and are used for security applications. For unanchored queries, the DQP 400 in the simplest configuration has full utilization of its leaf memory, and performs string queries at the rate of [query cycle rate]*[byte], by shifting one byte in the incoming string stream per query cycle. To increase this rate the DQP 400 needs to shift multiple bytes at a time; for example shift 2 bytes or 4 bytes or 8 bytes or 10 bytes or 20 bytes or more.

In one simple embodiment the solution is to replicate the string tree database by the speedup factor, and search each replicated tree by shifting the incoming string by one byte on one tree, by two bytes on the next tree, and by three bytes on the next tree and so on. In one preferred embodiment the unanchored string query speedup is achieved by replicating only the tag section; and maintaining a deep tree with high utilization of leaf memory. In this case the replicated tags (for different byte shifts) would point to the same path at the next level (map2 or branch map) via the map1 or stem map; and achieve database utilization close to that at the slowest rate. When the unanchored string data rate is slower than the normal anchored patterned data rate; the available bandwidth enables storage of a deeper tree bucket for the slower unanchored string database.

An advantage of the DQP 400 is that it allows dynamic updates of anchored and unanchored strings unlike other solutions including state based Aho-Corassick algorithm. Pattern based solutions also require multiple changes to the pattern memory, and matching tables for a single update. The DQP 400 also achieves very high memory utilization even with higher speedup; unlike the state based methods including Aho-Corassick algorithm which suffers memory explosion with longer pattern length and number of patterns; and pattern based solutions that require significantly more TCAM or pattern match resources, and replicated matching table entries to compensate for multiple pattern matching. Bloom filter based solutions suffer from false positives, limitations for updates, and need for build a bloom filter for various pattern lengths.

Building a Database Tree in the DQP

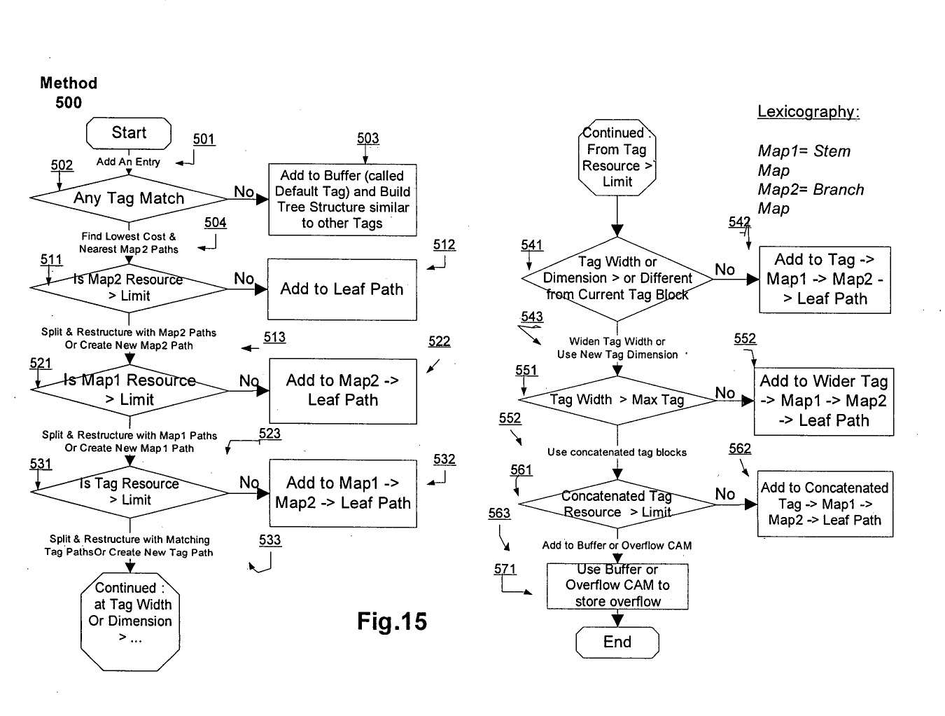

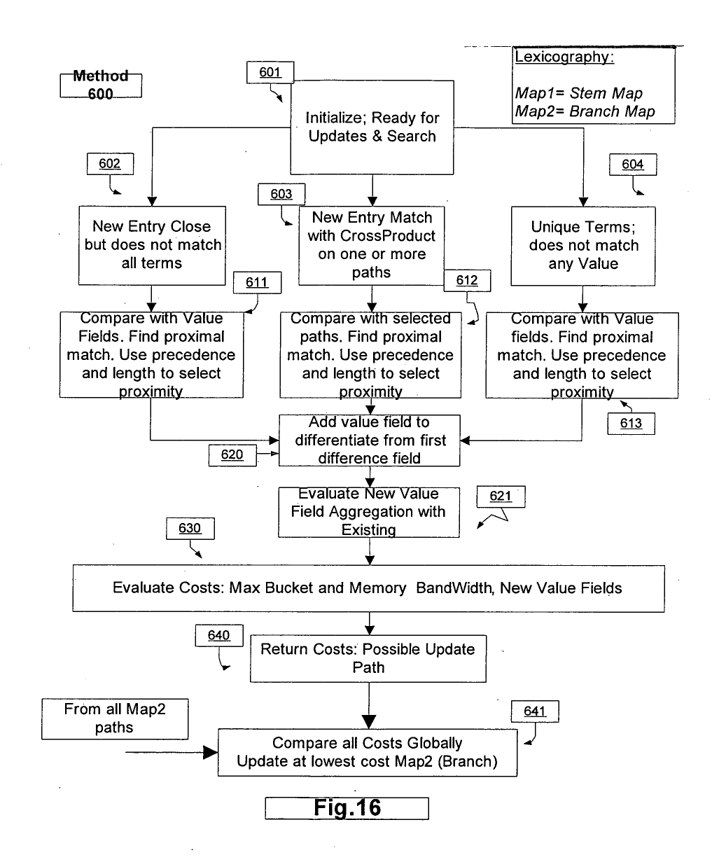

FIG. 15 illustrates a process flow of a method 500 for building a database tree while adding an entry to a database. The process is applied to a 4 stage database tree (as in FIG. 14). The method 500 includes a set of steps, decisions and evaluations and the process steps are described herein. Although by the nature of textual description the process steps, decisions and flow points are described sequentially; there is no particular requirement that these steps must be sequential. Rather, in preferred embodiments, the described steps, decisions and flow points are performed in parallel or in a pipelined manner.

Flow point 501 is an entry addition command. The decision step 502 is a search of all tag blocks for matching tag with incoming entry. If no matching tag is found the entry is added to a temporary buffer and a tree learning structure (for future merge to other tags) in process 503; similar to other tags. If matching tags are found, the flow point 504 evaluates cost (bandwidth, memory resources) and nearest paths on each traversed path. At decision point 511 the likely paths are evaluated if the last mapping stage (map2) needs more resources than available to add the new entry.

At flow point 513, the map2 path is split and restructured if the map2 stage needs more resources; and new entry is written to one of the paths: old map2 path or the new map2 path. The nearest path information is used during split and restructuring so that nearest entries and value buckets are placed together. Statistics information such as count in each value bucket and precedence information is used so that nearest entries and tree hierarchy is considered during split. At process step 512 the entry is added to the existing map2 path and resources, if no additional mapping resources are need.

At decision point 521 the existing map1 path's resources all (map2 path resources) relative to the additional resources. If map1 resources are available the process step 522 is executed and the entry is added to an allocated map2 path. If map1 resources are not sufficient, at flow point 523 the existing map 1, path is considered for splitting and restructuring (splitting and merging). Decision point 531 considers if there are sufficient resources to add the entry to the existing tag. In process step 532, if the tag resources are sufficient than the entry is added to the existing tag on the map1 path (old or newly created in flow point 523). If the tag resources are not sufficient to add the entry than the existing tag is split and a new tag is created at flow point 533.

At decision point 541; it is examined if the new tag to be created needs fields and data that is not accommodated in the existing tag block. If the entry can be accommodated in the existing tag then it is added by process step 542. If the new tag requires additional fields, and hence, a differently configured tag block (configuration in terms of widths and or data fields) then flow point 543 is executed. As the database grows and the dense areas of tree may require wider tag width or new dimensions to differentiate from other entries.

Decision point 551 examines if the new tag to be created is wider than a single tag block width. If the entry can be accommodated in a single tag then it is added by process step 552. If a required new tag is wider than any configured tag block then flow point 553 is executed. Flow point 553 considers concatenating 2 different tag blocks to apply the effect of a much wider tag block. Databases with overlapping regions and the dense areas of tree may require wider tag width or new dimensions to differentiate from other entries.

Decision point 561 examines if the new tag to be created can be supported by the widest concatenated tag. If the entry can be accommodated in a concatenated tag then it is added by process step 562. If a new required tag is wider than any configured tag block then flow point 563 is executed. Flow point 563 adds the entry to the temporary buffer through process step 571 to learn a new structure and to hold the overflow that cannot be supported by any of the previous steps.

Cost Evaluation of Mapping Stage 2 (Branch Map)

FIG. 16 illustrates a process flow of a method 600 for evaluating the cost of an update and finding of nearest paths while adding an entry to a database. In one embodiment, the process is applied to a 4 stage database tree, e.g., as illustrated by FIG. 14. The process is applied to a 4 stage database tree (as in FIG. 13). The method 600 includes a set of steps and the process steps are described herein. Although by the nature of textual description the process steps, decisions and flow points are described sequentially; there is no particular requirement that these steps must be sequential. Rather, in preferred embodiments of the invention, the described steps, decisions and flow points are performed in parallel or in a pipelined manner.

Process 601 is the initialization and configuration of map2 or branch map resources. When an entry is to be added steps 602, 603 and 604 are executed. The step 603 evaluates if the incoming entry matches some buckets but does not match the crossproduct. The step 602 evaluates if the incoming entry matches the crossproduct; in this case the stored leaf memory must be accessed to compare with incoming entry to find differentiation. The step 604 evaluates if no existing value bucket matched incoming entry; this means the new entry has unique value terms.

If the incoming entry matches some value fields and not the crossproduct (step 602); then step 611 evaluates which value field should be added. The hierarchy or precedence information is used to select the highest (precedence) value field. If splitting or restructuring of map2 is required (as seen in method 500) knowledge of the nearest value fields is used to split and restructure the branch map (map2). To optimize memory bandwidth maximum paths selected are limited to only 2 in one embodiment.

If the incoming entry matches the crossproduct (step 603); then step 612 compares incoming entry with entry(ies) in stored leaf memory to evaluate which value field should be added. Among candidates for new value field; the hierarchy or precedence information is used to select the highest (precedence) value field. If splitting or restructuring of map2 is required (as seen in method 500) knowledge of the nearest value fields is used to split and restructure the branch map (map2). To optimize memory bandwidth maximum paths selected are limited to only “Actual Matches”+2 in one embodiment. Since the crossproduct matches, the incoming entry can match one or more entries in the map2 path which are described as the number of entries that are “Actual Matches.”

If the incoming entry does not match any value fields (step 603); then step 613 evaluates which unique value field of the new entry should be added. The hierarchy or precedence information is used to select the highest (precedence) value field. If splitting or restructuring of map2 is required (as seen in method 500) knowledge of the nearest value fields is used to split and restructure the branch map (map2). To optimize memory bandwidth maximum paths selected are limited to only 2 in one embodiment.

The process step 620 decides which value field(s) is/are to be added for the new entry as per precedence or database hierarchy. The step 621 does further optimizations with the new value field(s) such as aggregation with existing value fields and subsequent memory bandwidth (should not exceed the limit selected in the applicable previous step either 611 or 612 or 613. Then process step 630 assembles the evaluated costs and proximity information. And the step 640 sends (or returns) the applicable information to the update controller (206 in e.g., FIG. 13). In step 641 the update controller compares all the costs from all global paths and decides to add entry at the most primal, lowest cost path. In one embodiment the most proximal or nearest path could be selected and in another embodiment the lowest cost path can be selected.

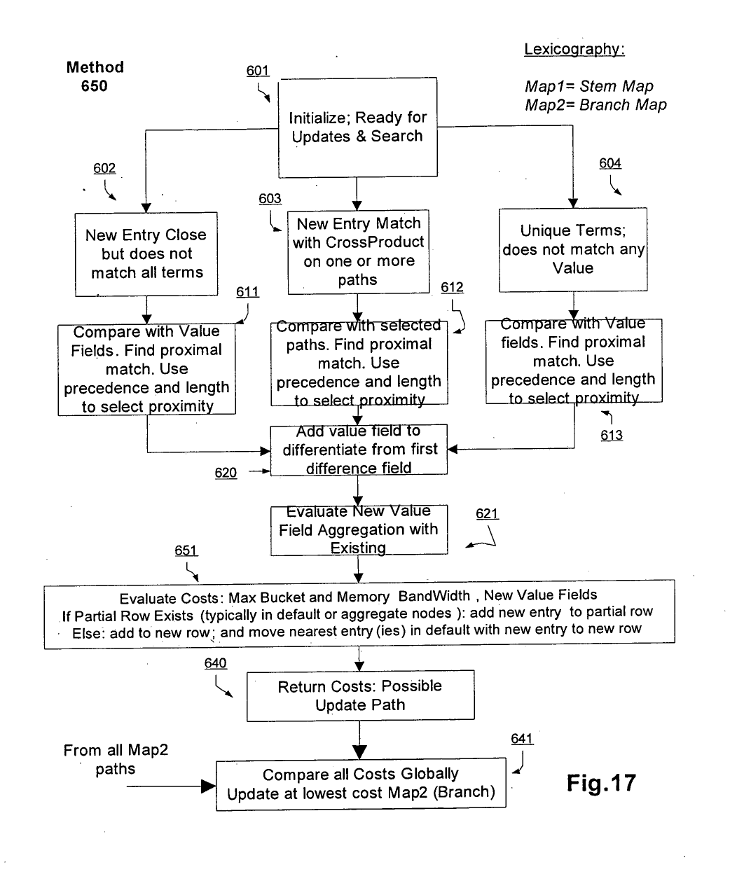

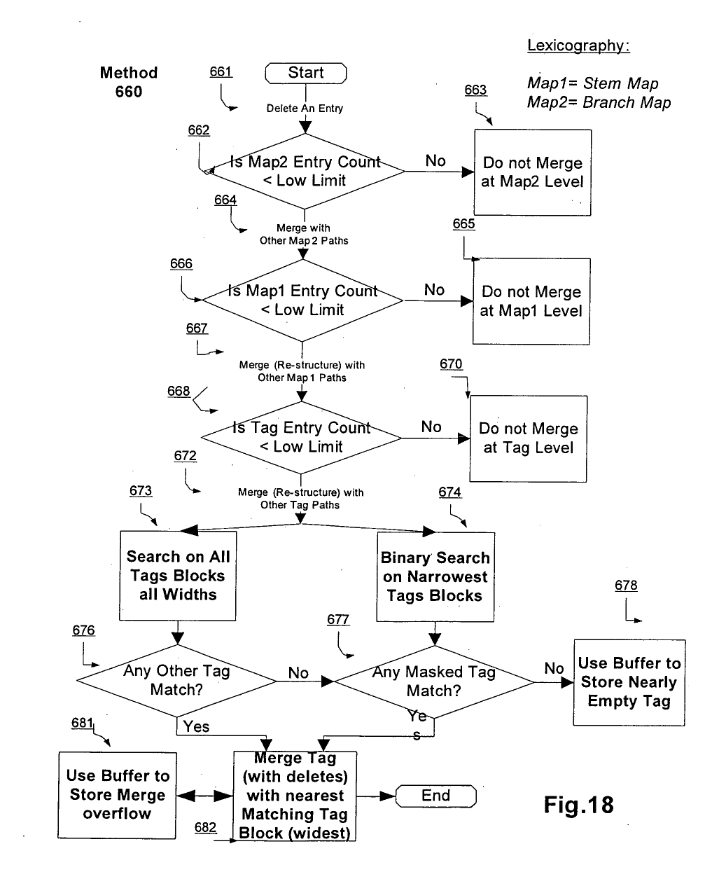

FIG. 17 illustrates a process flow of a method 650 for evaluating the cost of an update and finding of nearest paths while adding an entry to a database which can store multiple entries to leaf memory row. In one embodiment, the process is applied to a 4 stage database tree, e.g., as illustrated by FIG. 13). The method 650 includes a set of steps and the process steps are described herein. Although by the nature of textual description the process steps, decisions and flow points are described sequentially; there is no particular requirement that these steps must be sequential. Rather, in preferred embodiments of the invention, the described steps, decisions and flow points are performed in parallel or in a pipelined manner.

In one embodiment, the method is similar to the steps disclosed except one; the step 630 in method 600 is replaced by step 651 in method 650. The step 651 enables optimization for partial rows (which can occur when multiple entries are mapped to one row); a new entry is preferably added to a partial row first. If the partial row happens to on a more specific path and bandwidth limit (is in one embodiment “Actual Matches”+2; then the entry can be added with no additional cost. If the partial row happens to be in an aggregated row; then new entry can be added as long as the bandwidth is <=“Actual Matches”+2. If the partial row is in an distant path; then a move operation can be used to move the entries between the aggregate and specific path (distant) considering overall bandwidth costs etc. Finally a new value field can be added to aggregate the new entry with any path (including distant entries in same row).

Delete and Merge Process in Database Tree

FIG. 18 illustrates a process flow of a method 660 merging and restructuring a database tree while deleting an entry to a database. In one embodiment, the process is applied to a 4 stage database tree, e.g., as illustrated by FIG. 13 or 14. The method 660 includes a set of steps, decisions and evaluations and the process steps are described herein. Although by the nature of textual description the process steps, decisions and flow points are described sequentially; there is no particular requirement that these steps must be sequential. Rather, in preferred embodiments of the invention, the described steps, decisions and flow points are performed in parallel or in a pipelined manner.

Flow point 661 is an entry deletion command. At the decision step 662 the likely path is evaluated if the last mapping stage (map2) is using resources below a limit (for example, 50% of map2 capacity). At process step 663 the entry is added to the existing map2 path and resources, if the resources are >50% (for example). At flow point 664, the map2 path is merged and restructured with other map2 paths at its branch level; and new entry is written to one of the paths: old map2 path or the new merged map2 path. The nearest path information is used during merging and restructuring so that nearest entries and value buckets are placed together. Statistics information, such as count in each value bucket, and precedence information is used so that nearest entries and tree hierarchy is considered during split.

Decision point 666 tests the existing map1 path's resource utilization to check it has not gone below a limit of say 33%. If Map1 resources are used at greater than low limit, the process step 665 is executed and the entry is added to an allocated map1 path. If map1 resources are below low limit, flow point 667 considers the existing map1 path for merging and restructuring. Decision point 668 considers if existing tag resources are used at greater than or equal to low limit. In process step 670, if the tag resources are below low limit, than the entry is added to the existing tag on the map1 path (old or newly created in flow point 523). If the tag resources are below low limit, than the existing tag is to be merged with existing tags at flow point 672.

The process step 673 executes a search of the incoming entry (to be deleted) with all existing tags. If a match is found than the tag path which is using resources below low limit will attempt merge with the nearest tag found. By merging with nearest tag (based on database hierarchy) the tree balance and structure is maintained. Alternatively, if no other tag match is found, then a masked tag query is executed in the narrowest tag block in decision step 677. The masked query search on the narrowest tag block can be executed in a binary search fashion or any specific method set for based on knowledge of database and other information. If no other tag match including masked tag mask on narrowest tag block fails than the depleted tag (resources used below low limit) can be added to the temporary buffer, and a tree structure learnt within the temporary buffer space. The process step 678 shows merging and restructuring.

The process step 682 shows merging and restructuring between depleted tag and the nearest matching tag. Any overflows are allocated to the temporary buffer 681.

Mapping a Database Tree to a Database Query Processor

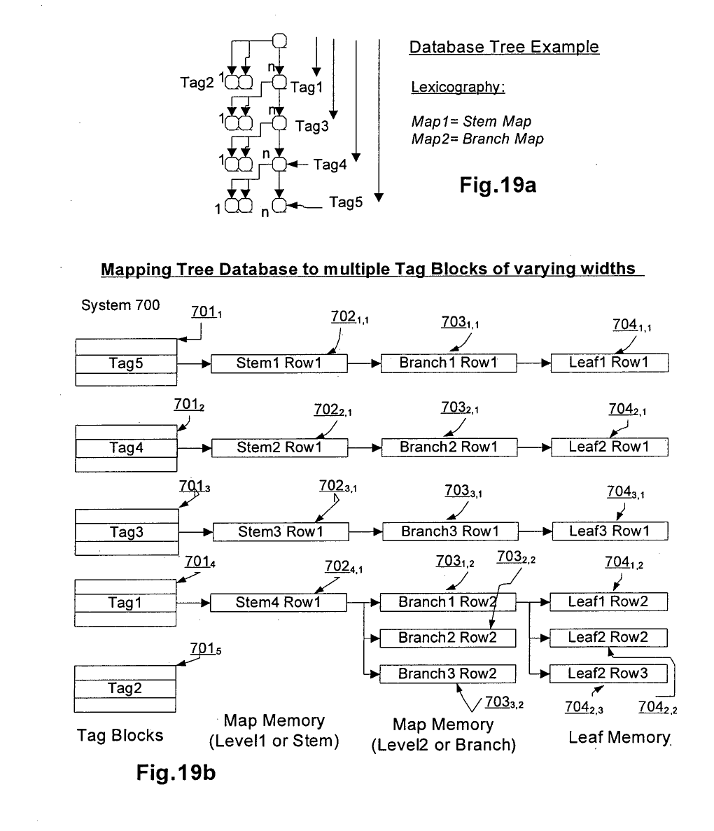

FIG. 19a illustrates one embodiment of a database tree. In one embodiment the first major branch is at Tag1 which one of n children of the root node. Tag1 has n children, of which the nth child is a major branch node Tag2. Tag2 in turn has n children, of which the nth child is a major branch node Tag3. Tag3 in turn has n children, of which the nth child is a major branch node Tag4. Tag4 in turn has n children, of which the nth child is a major branch node Tag5. This database represents an example of a case of overlapping regions and selectively dense paths.

FIG. 19b illustrates one embodiment of how the above database with overlapping regions (wildcards) and selectively dense paths could be mapped to an embodiment of the database query processor (DQP). Each major node branch is mapped to a separate tag block when the children within it exceed the limits of the tag capacity or the differentiating resources (value fields) cannot keep the maximum paths read or memory bandwidth below limit (see method 500). The ability of the DQP to support overlapping databases depends critically on the number of entries supported per tag so a limit is placed on number of parallel matching tags.

Secondly, multiple separate tags need to be processed in the case of overlapping database regions. In the example Tag5 is stored in tag block 701₁, and Tag4 in tag block 701₂, and Tag3 in tag block 701₃, and Tag1 in tag block 701₄, and Tag2 in tag block 701₅. Each tag has a one stem map row, and one or more branch map row(s) and each branch map row has one or many leaf rows. Stem map rows have a one to one associativity with the configurable tag rows. Each tag can be of varying length or using different dimensions. Branch map rows are allocated from available branch memory blocks. FIG. 19b illustrates an example of inserting an entry the path Tag1 (in block 7014)-->Stem4 Row1 (stem map block 7024,1)-->Branch1 Row2 (in block 703_{1,2})-->Leaf2 Row2 (leaf block 704_{2,2}). The new entry is allocated Leaf2 memory only because the other matching paths (via other matching tags) do not have an eligible match in Leaf2. Hence, the new entry can be allocated to Leaf memory 2. All allocation decisions for entry updates follow this principle of no conflict of memory bandwidth resources to ensure deterministic query rate.

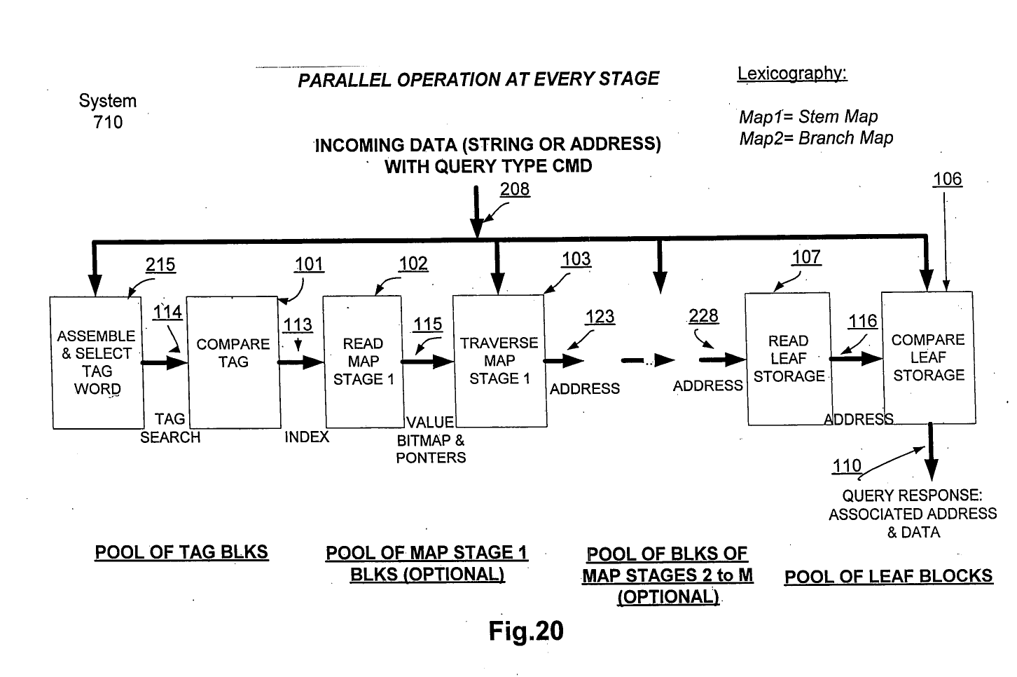

The FIG. 20 illustrates one embodiment of the system 700 for the DQP query pipeline. FIG. 20 shows data transfer and control transfer to select likely paths to perform a query. As an example, reference is made to a figure of the DQP in FIG. 13. The FIG. 20 shows an example of data transfer and control transfer to select likely paths to perform a query.

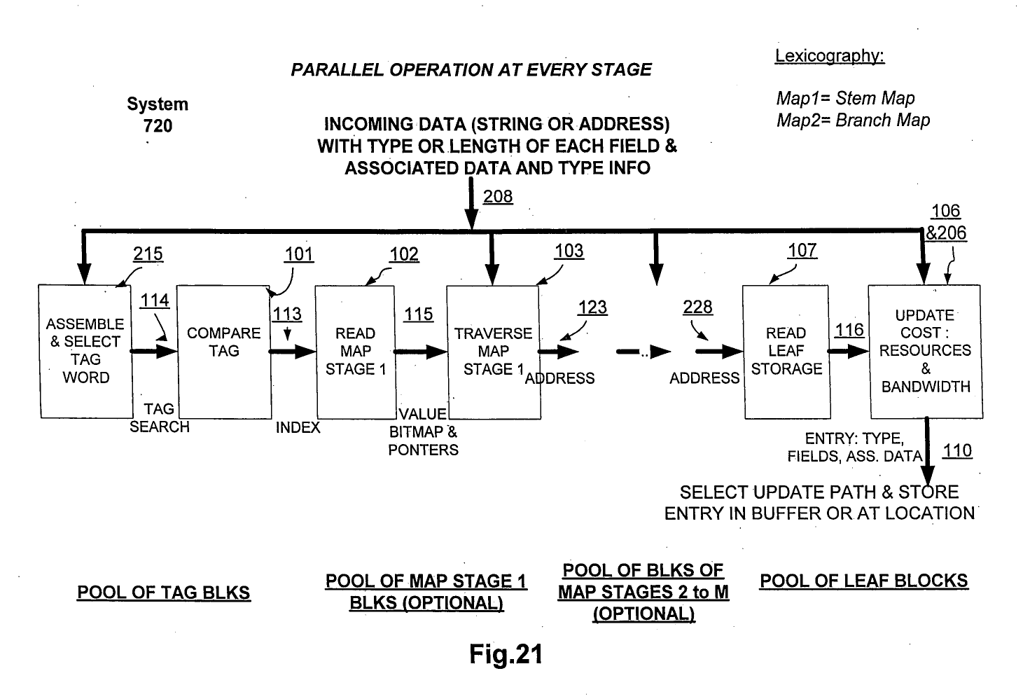

FIG. 21 illustrates one embodiment of a system for the DQP update path allocation pipeline. As an example, reference is made to the DQP of FIG. 13. The FIG. 21 shows an example of data transfer and control transfer to select likely paths to perform an update while picking the lowest cost resource and keeping memory bandwidth below programmed limit.

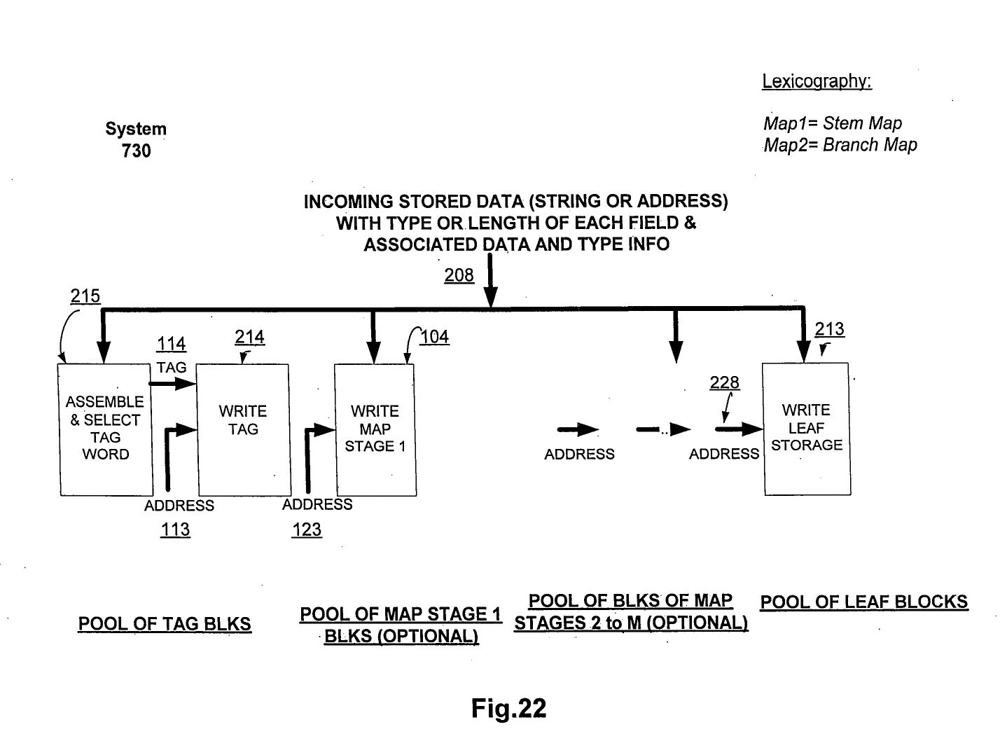

FIG. 22 illustrates one embodiment of a system for the DQP update write pipeline. As an example, reference is made to figure of the DQP of FIG. 13. The FIG. 22 shows an example of memory write operations to tag, stem map, and other maps, and leaf memory resources.

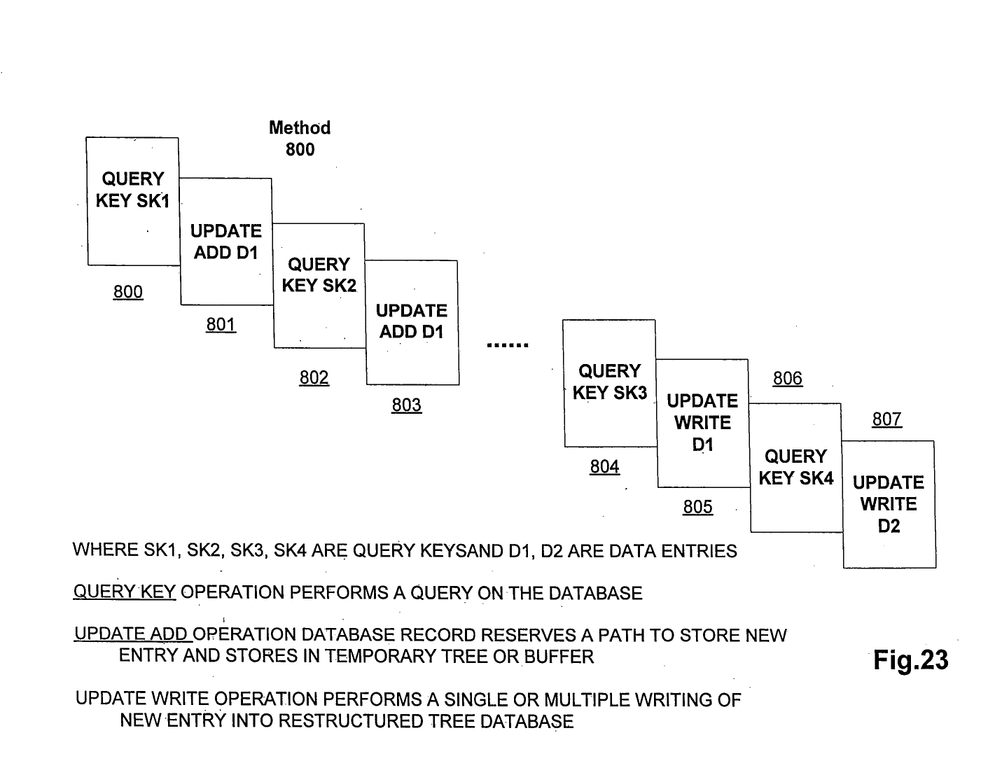

The FIG. 23 illustrates one embodiment of the method 800 for a sequence of pipelined DQP query, update add. (update path allocate), and update write operations. This illustrates how the device can achieve high pipelined query and update performance.

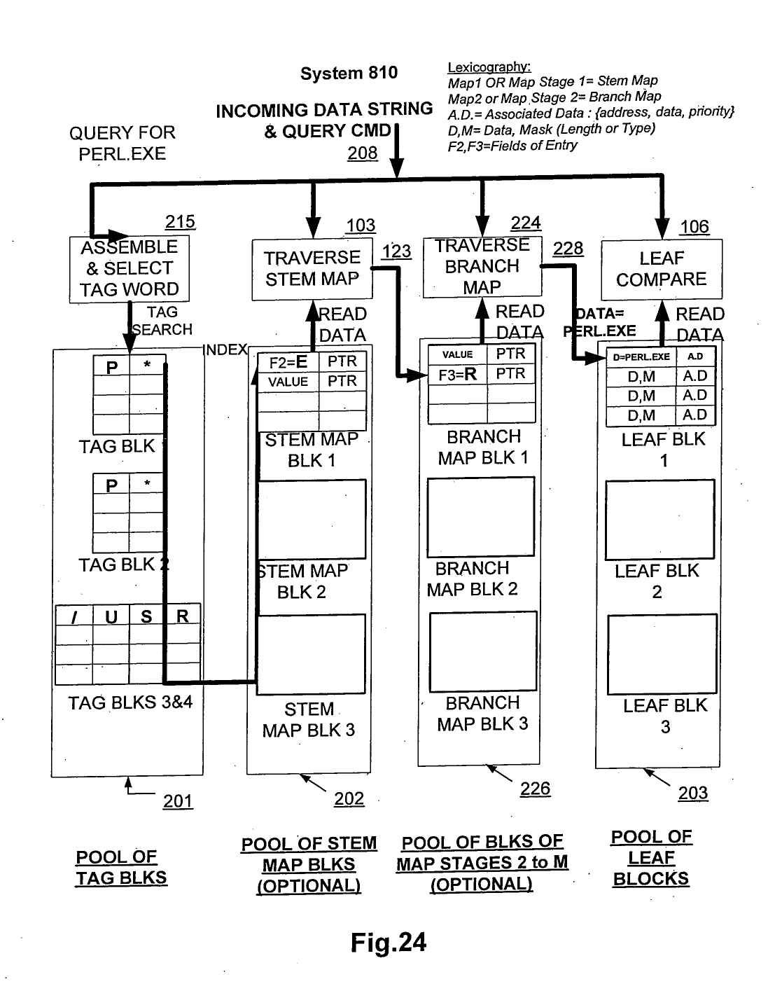

The FIG. 24 illustrates one embodiment of the system 810 for the DQP string query pipeline. The reference figure of the DQP is FIG. 14. The FIG. 24 illustrates how an query for the string “PERL.EXE” traverses a tag block with a tag P.* pointing to a stem map with value in field2 as E, and pointing to branch map having value of E in field3 and finally pointing to a string entry called perl.exe in the leaf memory. The figure shows how 2 character and 4 character tag blocks can be used. The example shows that in the 2 character tag block, tag masking is used to control path selectivity as appropriate to the tree branch and the density of the branch. It is not necessary for the order of fields at each stage to be in order or contiguous; the fields are shown to be sequential and contiguous for ease of understanding. For strings that are longer than the longest search word supported in the array; the partial hit table is used to store the significant sections of these strings. The partial hit table and the partial hit processor together perform string (or grammar) loading, string comparison and string elimination. In one embodiment, some or all of the partial hit table could reside on a processor coupled with the DQP. Unanchored and anchored string matching and speedup of unanchored stream queries have been discussed in the description of FIG. 14.

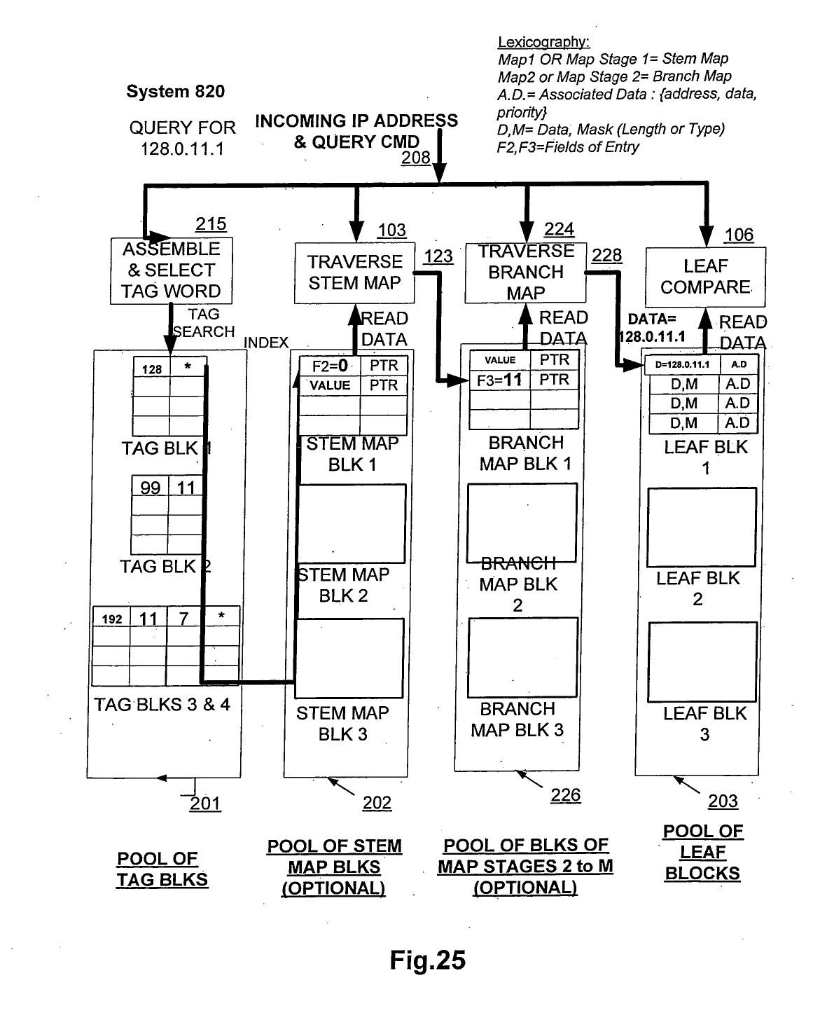

The FIG. 25 illustrates one embodiment of the system 820 for the DQP query pipeline. The reference figure of the DQP is FIG. 13. The FIG. 25 illustrates how an query for an IP address “128.0.11.1” traverses a tag block with a tag 128.* pointing to a stem map with value in field2 as 0, and pointing to branch map having value of 11 in field3 and finally pointing to a string entry called 128.0.11.1 in the leaf memory. The figure shows how upto 16 bits of the IP address and upto 32 bits of the IP address bits can be used to store the root node in the tag. The example shows that in the 2 byte (16 bits) tag block, tag masking is used to control path selectivity as appropriate to the tree branch and the density of the branch. It is not necessary for the order of fields at each stage to be in order or contiguous; the fields are shown to be sequential and contiguous for ease of understanding.

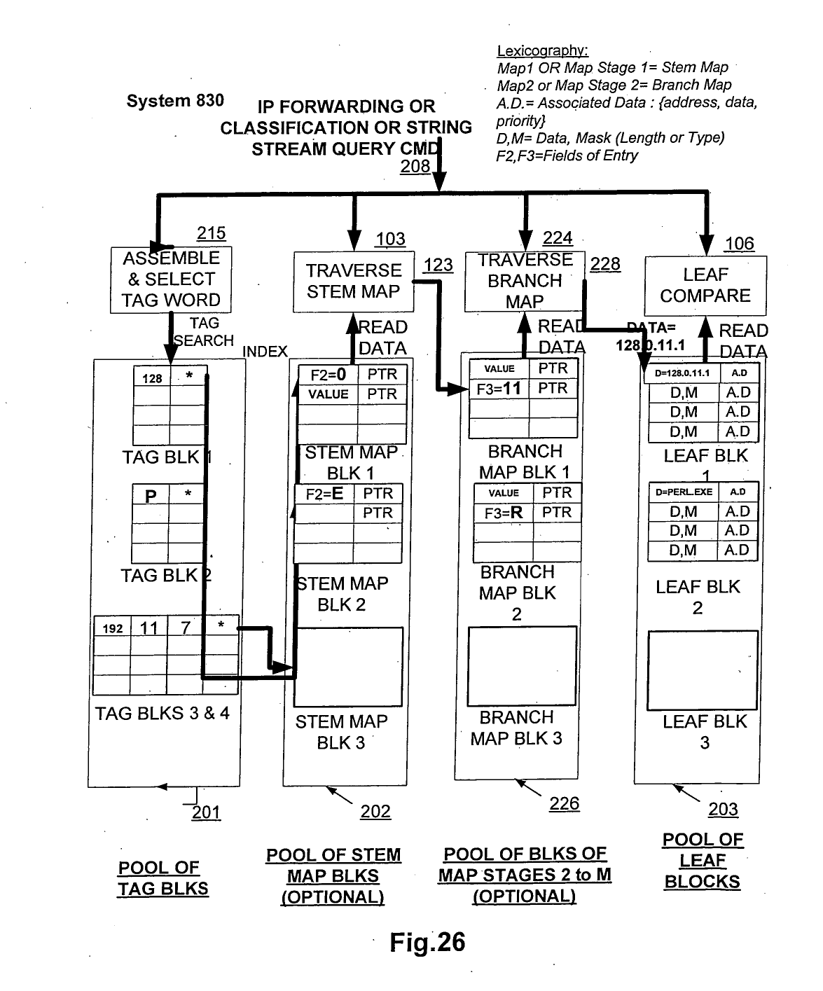

The FIG. 26 illustrates one embodiment of the system 830 for the DQP string query pipeline and an UTM (Unified Threat Management) application. UTM appliances perform routing functions: forwarding and classification; and content search to provide security by performing string search on internal packet payload (including decrypted and de-compressed packet payloads). In one example, reference is made to the figure of the DQP of FIG. 14. The FIG. 26 shows an example of a query for an IP address “128.0.11.1.”, and also shows storage of string rule PERL.EXE along with classification rules in the DQP 400.

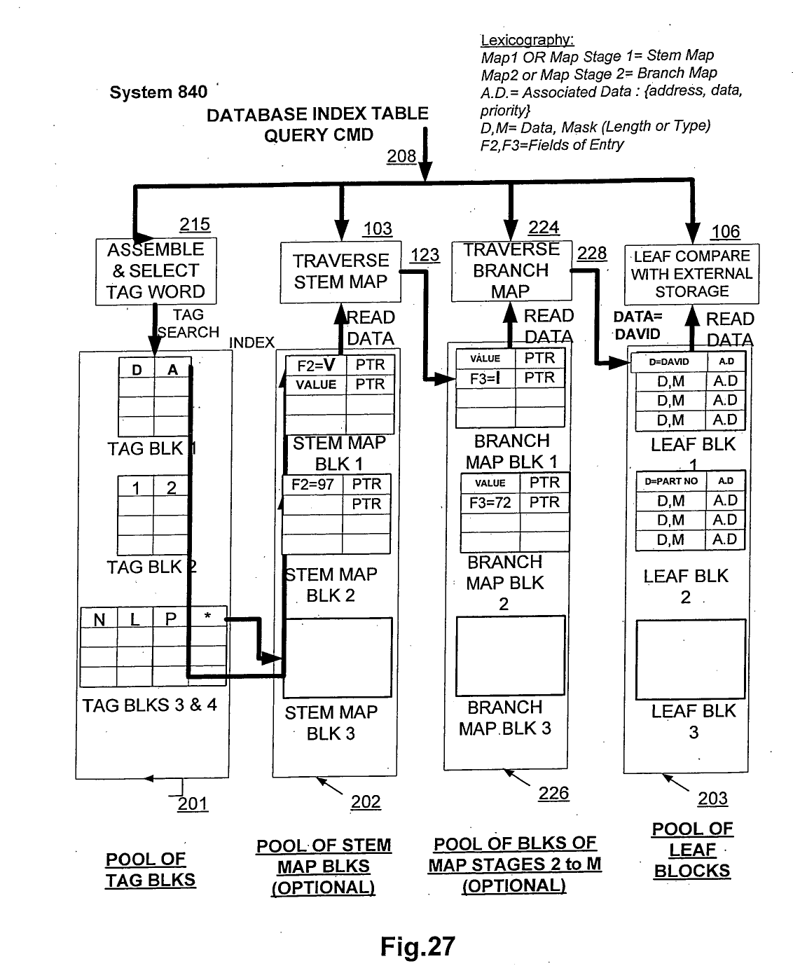

FIG. 27 illustrates an embodiment of a system 840 for the DQP query pipeline and a database acceleration application. In one example, reference is made to the figure of the DQP 400 of FIG. 14. The FIG. 27 shows an example of a query for a customer “DAVID” using a customer name based index table. The FIG. 27 also shows the DQP with storage of other database index tables such as one for PART NO. (based on part number), and another index table constructed from multiple fields of N=name, L=location, P=part number. This example also shows that the memory leaf storage utilizes external memory to increase the capacity of the index table, as many database applications require large index tables.

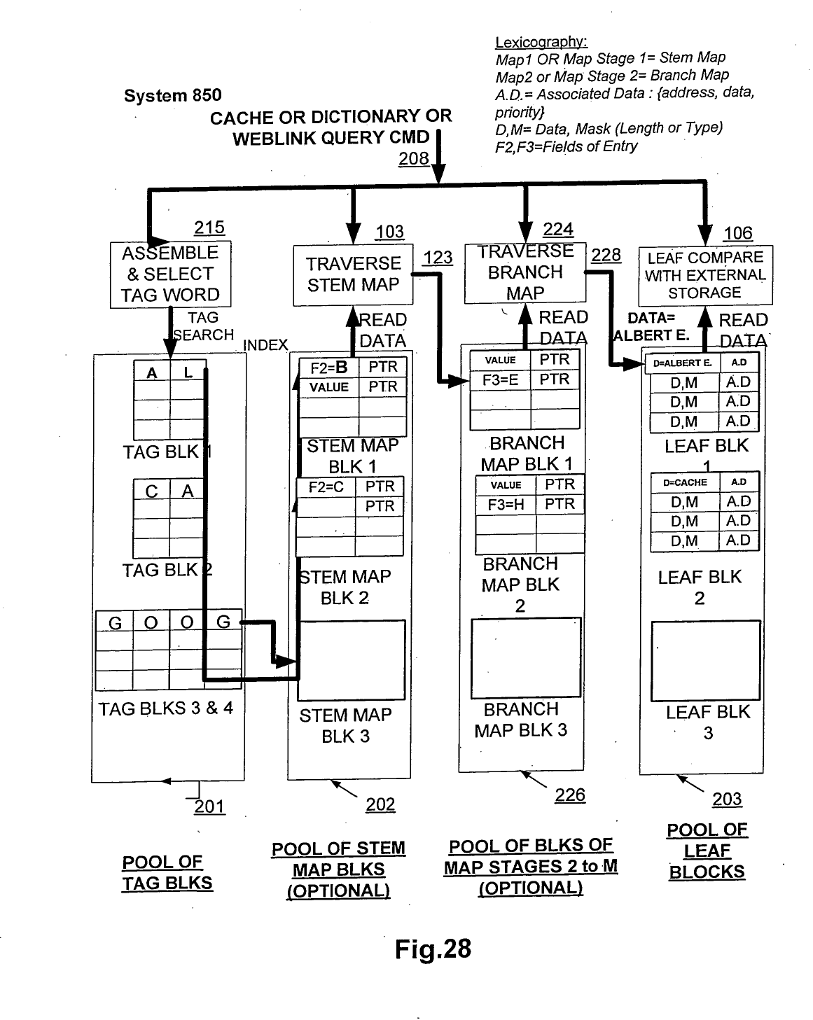

FIG. 28 illustrates an embodiment of a system 850 for the DQP string query pipeline for a cache and data mining application including dictionary and weblinks. In one example, reference is made to the figure of the DQP 400 of FIG. 14. The FIG. 28 shows an example of a query for a cache or data mining lookup for “Albert E.” The same figure shows storage of weblinks database with an example “goog” in the tag for www.google.com, and a dictionary database with an example “cache”. The example also shows memory leaf storage utilizes external memory as large capacity is required.

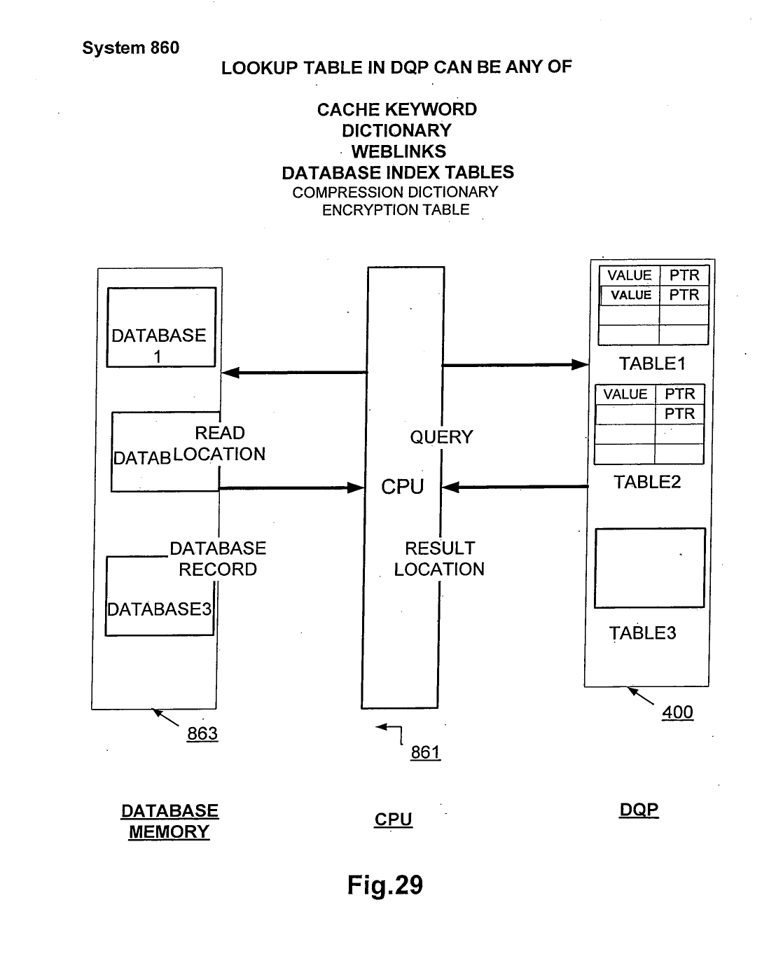

FIG. 29 illustrates an embodiment of a system 860 with a CPU and DQP storing the lookup tables and database memory. In one example, reference is made to the figure of the DQP 400 of FIG. 14. The FIG. 29 illustrates a database or data mining processing system. The CPU(s) 861 issues a query to lookup up the tables in the DQP 400. The DQP 400 can be an electronic system with external memory to provide higher capacity. The DQP 400 obtains the location of queried object (could be dictionary word, cache keyword(s), weblink, database index fields). The CPU 861 loads the queried object from the database memory 863 and performs necessary processing.

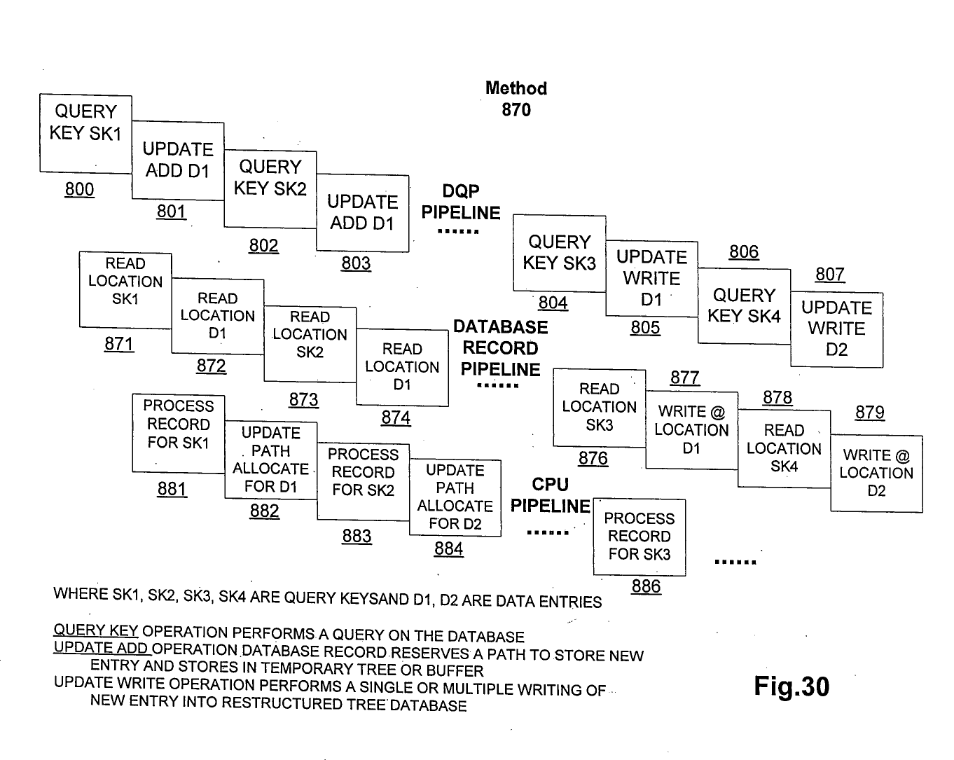

FIG. 30 illustrates an embodiment of a system pipeline with a CPU and DQP storing the lookup tables and database memory. In one example, reference is made to the figure of the DQP of FIG. 14. Method 870 in FIG. 30 illustrates an embodiment of a system pipeline with a CPU and DQP storing the lookup tables and database memory. In one example, reference is made to the figure of the DQP 400 of FIG. 14, although any embodiment of DQP can be used. The system pipeline shows how the CPU and DQP 400 continue with their pipelined processing without stalls. The pipeline also shows how the DQP 400 (step 801) and CPU (step 882) co-operate to allocate the storage path for a new or modified database record (step 872) and associated lookup table. Similarly step 800 is a query on key SK1 the DQP, and step 871 is a read from the identified database record(s), and step 881 is the CPU processing on the record(s) for query key SK1.

The DQP can be applied to accelerate pattern matching on complex databases such as those used in bio-informatics or scientific computing in various ways. For example in bio-informatics the DQP can first identify sections of records that match to incoming DNA or protein patterns; and then load the full records of the above identified database records onto the DQP and further performing comparison of the loaded records with very large patterns and calculate a score of closeness for each record by combining scores of each section, and further processing the the highest ranked records. The DQP by performing pattern matching simultaneously on very large record sets performs parallel computing and accelerates performance beyond the capability of a large set of CPUs. Additionally the DQP has ability to process, update and write onto multiple paths, enabling advanced tracking or score keeping functions. Further, additional levels of recursion of database searches (recursive searches) can be used with the DQP. Many complex applications require patterns to be matched and further processing of state tables or grammar and/or probabilistic values attached to each pattern. The DQP addresses these by performing complex (expression) pattern matching, accessing storage defining further records and additionally enabling various methods of fast updates.

Example Embodiments

In one embodiment an integrated circuit device includes a CAM (TCAM inclusive) word that can be combined to be of wider width (1 to m times) such as 2 times, or 4 times or 8 times or 16 times or more, to store the BFS (Breadth First Search) component of a trie which generates an index to access a mapping memory. A mapping memory is accessed by an index generated by the CAM array, which stores a plurality of values to store a trie structure; and a plurality of pointers. A mapping path processing logic compares values stored in trie structure with query key components and generate pointers to a next mapping stage or leaf memory. In one embodiment, there is also multiple stages of mapping memories and associated mapping path processing logic. The leaf memory accessed by pointer storing a plurality of partial or full records of state tables or grammar or statistical or compute instructions. A result generator that compares query key components with record stored in leaf memory and generates match result along with stored parameters.

In another embodiment, an integrated circuit device includes a plurality of CAM (TCAM inclusive) word arrays that can be combined to be of wider width (1 to m times) such as 2 times, or 4 times or 8 times or 16 times or more, to store the BFS (Breadth First Search) component of a trie which generates an index to access a mapping memory. In addition, a plurality of mapping memories is accessed by an index generated by the CAM array that stores a plurality of values to store a trie structure; and a plurality of pointers. For each group of mapping memories, a mapping path processing logic compares values stored in trie structure with query key components and generate pointers to a next mapping stage or leaf memory. Also includes may be multiple stages of mapping memories and associated mapping path processing logic. A plurality of leaf memories is accessed by a pointer storing a plurality of records of state tables or grammar or statistical or compute instructions. A result generator compares query key components with record stored in leaf memory and generates match result along with stored parameters. An output generator combines the results from each result generator and outputting results in response to specific query type.

In yet another embodiment, an electronic system includes a CAM word (TCAM inclusive) that stores the BFS (Breadth First Search) component of a trie which generates an index to access a mapping memory. The mapping memory, accessed by index generated by the CAM array, stores a plurality of values to store a trie structure and a plurality of pointers. The mapping path processing logic compares values stored in the trie structure with query key components and generates pointers to next mapping stage or leaf memory of state tables or grammar or statistical or compute instructions. There also may be multiple stages of mapping memories and associated mapping path processing logic. The leaf memory is accessed by a pointer storing a plurality of partial or full record. A result generator compares query key components with a record stored in leaf memory and generates match result along with stored parameters.

In addition, in an alternative embodiment, the CAM storage of the electronic system can store any part or any arbitrary parts of the record and not necessarily the prefix or suffix. Further, the system can be configured so that zero to many stages of mapping memory stages may be accessed.

In still another embodiment, an electronic system includes a CAM (TCAM inclusive) word that can be combined for wider width (1 to m times) such as 2 times, or 4 times or 8 times or 16 times or more, to store the BFS (Breadth First Search) component of a trie which generates an index to access a mapping memory. The mapping memory, accessed by an index generated by the CAM array, stores a plurality of values to store a trie structure; and a plurality of pointers. A mapping path processing logic compares values stored in trie structure with query key components and generates pointers to next mapping stage or leaf memory. It is noted that there may be multiple stages of mapping memories and associated mapping path processing logic. A leaf memory, accessed by pointer, stores a plurality of partial or full records of state tables or grammar or statistical or compute instructions. A result generator compares query key components with record stored in the leaf memory and generates match result along with stored parameters. Further, an electronic system may accelerate database searches by storing various index tables constructed from one or many fields onto a DQP using external memory to increase capacity.

In another embodiment, an electronic system includes a plurality of CAM word arrays that can be combined to be of wider width (1 to m times), for example, 2 times, 4 times 8 times or 16 times or more, to store the BFS (Breadth First Search) component of a trie which generates an index to access a mapping memory. A plurality of mapping memories, accessed by an index generated by the CAM, stores a plurality of values to store a trie structure and a plurality of pointers. For each group of mapping memory, a mapping path processing logic compares values stored in trie structure with query key components and generates pointers to next mapping stage or leaf memory. There may be multiple stages of mapping memories and associated mapping path processing logic. A plurality of leaf memories, accessed by a pointer, stores a plurality of records of state tables or grammar or statistical or compute instructions. A result generator compares query key components with record stored in leaf memory and generates match result along with stored parameters.

The electronic system also may be configured for accelerating cache or data mining searches for dictionary word(s) or weblinks by storing lookup tables constructed from one or many fields used to store data into the cache or to lookup a dictionary or weblinks onto a DQP using external memory to increase capacity. In addition, the electronic system may store and query various entry types including single or multiple field database index tables or redo logs or other database tables and perform simultaneous queries of each applicable database.

In one embodiment, further reference is made to an output generator. The output generator combines results from each result generator and outputs results in response to specific query type. In addition, support for multidimensional database overlaps regions by supporting a) multidimensional crossproduct in mapping stages, b) parallel CAM (TCAM inclusive) node paths, and c) all fields and dimensions (individually and combined), which can be stored in configurable CAM (TCAM inclusive) nodes.

An electronic system (or integrated device) also may store and query various entry types including strings, content rules, classification and forwarding tables and perform simultaneous queries and processing of each applicable database. The electronic system may store and query various entry types including single or multiple field cache lookup tables or dictionary tables or weblink tables and perform simultaneous queries of each applicable database. The electronic system may allocate trie traversal memory paths for new entries by using free lists for each applicable memory, selecting only unallocated memories, using cost optimization to choose an memory path so that balance is achieved on available free rows in each memory, while also considering physical hierarchy or connectivity. The electronic system also may perform an associativity mapping from a set of p tag blocks of minimum width onto fewer k memory map1 (stem map) blocks. The larger number of tag blocks can be combined into longer words but fewer tag entries; hence reducing the equivalent number tag associativity from p to k tag blocks. This is includes configurable tag blocks and configurable associativity between tag blocks and mapping memory.

In another embodiment, an apparatus provides many parallel trie traversal paths from tag to mapping memory to next mapping memory and eventually leaf memory. The apparatus may provide varying root node lengths or widths or dimensions by configuring tag width, and by concatenating tag entries in multiple tag blocks and combining via mapping memory pointers and control. In addition, an apparatus may update an entry by modifying selectively one or two paths only and by affecting a very short tree. The means may be facilitated by the controllable differentiating or aggregation features available in the mapping stages. Further, an apparatus may provide controllable differentiation or aggregation at each stage in the DQP. The apparatus may include controlling length of each field, combining multiple fields at each level of the DQP and using various crossproduct combinations in the mapping stages.

Embodiments of the present invention also include a method to limit the memory bandwidth while querying entries by using multi-dimensional crossproduct bitmap, while simultaneously supporting aggregated storage of branch and leaf nodes. In addition, a method to optimize memory bandwidth and resources is used to store database entry, whereby a database entry can be stored as a CAM (TCAM inclusive) node product or a CAM (TCAM inclusive) node only at stem or branch or leaf node. There may also be a method to perform dynamic update for adding or deleting a record for an integrated device. In addition, there may be a method to allocate CAM (TCAM inclusive) array for each dimension and various node lengths to support a variety of data and spatial partitioning methods resulting in optimal use of the resources.

Still other embodiments include a process to support updates without restructuring an entire database. For example, there may be a sensitize update path to at most two paths, and at most affects only two CAM node, two stem or branch node and two leaf nodes. Similarly for entry deletion the update affects at most two CAM nodes, two stem or branch nodes and two leaf nodes. A data structure of the mapping data structure constituted n value bitmap fields and pointers to memory leaf storage or next memory mapping stage. A value bitmap structure may be constituted of a field identifier, a field value, a field length, and/or a population.

In another embodiment, a mapping path may be inferred by evaluating a crossproduct bitmap from each value bitmap using the reverse bitmap function. One memory leaf path or next memory map stage may be used as an aggregating node while using the other paths as selective or specific paths. A process may move the nearest or proximal entries in the default or aggregating node to selective or specific nodes while maintaining high utilization during updates. In addition, there may be a process that aggregates entries that could be assigned to specific paths but are actually aggregated to default or aggregating node to maintain high storage utilization. The process may aggregate two specific paths by reducing value field length.

In addition, in other embodiments, there may be a process for dividing a selective path into two selective paths by introducing new value fields or any field identifier as long as selectivity is gained. The process includes storing content rules, including strings, and performing both unanchored and anchored search on an incoming data stream. A process may include storing content rules in a trie traversal, performing search on incoming data stream, loading longer sections of a partially matching rule into a partial hit table, and further performing matching on incoming data stream and finally eliminating the content rule from partial hit table or declaring a content rule hit. The process also may include achieving speedup of unanchored search by mapping replicated tags onto same mapping path at the next level; while maintaining high leaf memory utilization. Further, embodiments may include a process for accelerating database searches by storing various index tables constructed from one or many fields onto a DQP using external memory to increase capacity.

In other embodiments, cache or data mining searches may be accelerated for dictionary word(s) or weblinks by storing lookup tables constructed from one or many fields used to store data into the cache or to lookup a dictionary or weblinks onto a DQP using external memory to increase capacity. A process also may infer a mapping path by evaluating a crossproduct bitmap from each value bitmap, using the reverse bitmap function using a specific set membership of higher hierarchy fields. In addition, a process may infer a mapping path by evaluating a crossproduct bitmap from each value bitmap, using the reverse bitmap function assuming higher hierarchy fields that are supersets belong to same path, and indicating the same for higher hierarchy fields that are equal sets.

Embodiments of processes include storing and querying various entry types including strings, content rules, classification and forwarding tables and associated information such as state tables, grammar, and instructions in one integrated device. Further, the process may include storing and querying various entry types including single or multiple field database index tables or redo logs or other database tables in one integrated device or electronic system. In addition, the process may include storing and querying various entry types including single or multiple field cache lookup tables or dictionary tables or weblink tables in one integrated device or electronic system.

Another embodiment includes a process for allocating trie traversal memory paths for new entries by using free lists for each applicable memory and selecting only unallocated memories. Further, the process includes using an cost optimization to choose an memory path so that balance is achieved on available free rows in each memory, while also considering physical hierarchy or connectivity.

Still other embodiments include a method of performing an associativity mapping from a set of p tag blocks of minimum width onto fewer k memory map1 (stem map) blocks. The larger number of tag blocks can be combined into longer words but fewer tag entries; hence reducing the equivalent number tag associativity from p to k tag blocks. The process may include performing an update insertion (add) by first performing an path allocation including an evaluation of resources required; and then updating so as to using the lowest cost means.

Embodiments of the process could include performing an update insertion (add) by using a higher degree of hierarchical path differentiation so as to keep low memory bandwidth. The process also attempts to use the lowest hierarchy resources first and then the next hierarchical resource or vice-versa for very fast updates. The resources tested in order include the empty leaf memory row then the previous mapping memory resources and then other mapping stages till tag resource is identified; and further using wider tag resource and further concatenating tag blocks fields.

In other embodiments, a process may include performing an update deletion by first performing an evaluation of path allocation for the resources utilized; and then considering merging to increase the utilization. The process could include performing an update deletion by using an evaluation of the resources used. When the resource utilization falls below a limit, the method attempts to merge the lowest hierarchy resources first and then the next hierarchical resource. The resources tested in order include the empty leaf memory row then the previous mapping memory resources and then other mapping stages till tag resource is identified; and further using narrower, tag resources and finally searching to merge onto masked sections of the narrowest tag blocks.

In still other embodiments, a process provides multi-dimensional path selectivity (or differentiation) within the mapping levels. The process may provide aggregation means at the mapping levels, and also by controlling tag width so as to achieve selective differentiation and high resource utilization. Further, the process may include learning a tree structure with every update, so that the cost of tree restructuring is very small but incremental at every update. The use of proximity or nearness information at every level of the trie is used to perform a move or restructuring of branches by use of pointers and moving at most only one leaf memory entry (in the case of multiple entries per row).

Further, the process may include a process and means to provide differentiation or path selectivity to entries that require higher memory bandwidth and have higher specificity; while preserving aggregation for default entries or less specific entries. The process encompasses each stage of the DQP trie path and enables controllable differentiation or aggregation on each path. A process may include using the DQP for complex databases by first identifying sections of records that match; and loading the full records of database or grammar or state tables and further performing comparison of the loaded records with very large patterns and keeping a score of closeness for each record by combining scores of each section, and further processing the highest ranked records.

Database Query Processor Support for Multi-Dimensional Database

The present invention beneficially provides extended support for multi-dimensional lookup tables or databases. For example, the present invention provides support for such databases as noted herein. First, there is support for random distributions of multi-dimensional data. For example, m Root nodes store a trie of maximum of n entries such that m*n=x*(total entries); where x is an number greater than 1: x signifies a measure of the degree of freedom to enable a practical and versatile solution. Root nodes can be as long as the entire entry or constituted from any combination of each dimension; this enables division of database into root nodes with maximum of n entries. The ability of root node to be as long as the entry ensures a small bucket size; unlike hashing or other trie methods which have large buckets (or collisions). For the worst case a root node must support an average of n/x entries with 100% utilization. The resources available in the mapping stages enable this without exceeding memory bandwidth and with high utilization of memory leaf resources. The effective length of the root node can be as long as the entry even when the entry (or record) is a multiple of the maximum search width in one search cycle. Longer words are searched at a slower rate corresponding to the length of the entry. This feature can be managed by concatenating tags in the indexed mapping memory resulting in longer root nodes. In other embodiments; methods of concatenating trie nodes can be used at any level of the trie.

Second, there is support for a multi-dimensional lookup table or database with overlapping regions; overlapping regions occur due to use of wildcard in one or more fields or dimensions. Overlapping database regions tend to cause large bucket of entries; this bucket size can be larger than the maximum storage possible within a root node. Multiple arrays enable efficient processing of these large overlapping buckets; overlapping regions are processed by parallel node arrays. Multiple arrays for root nodes enable efficient partitioning of overlapping regions by each root array; resulting in low memory bandwidth. An advantage of supporting larger number of entries per root node is reduced memory bandwidth when there is a high number of overlapping regions; by requiring fewer active root nodes in multiple arrays.

Third, there is support for dense and sparse tree branches. Dense and sparse branches are supported efficiently. The ability to define variable length and flexibly masked root node ensures this. Dense branches tend to have longer root nodes: as there are relatively more children in lookup table (or database) tree at any step in trie traversal; while sparse branches have shorter root nodes.

Fourth, there is optimal use of memory bandwidth. Memory bandwidth increases when there are large buckets from a trie node. The mapping resources use a crossproduct bitmap function which elegantly partition data within a root node. The differentiating resources in the mapping stages (stem and branch mapping in best mode) ensure that only one or two memory leaf paths are accessed. A cost function is built in the update processing so that memory bandwidth does not exceed limits defined.

Fifth, there is a high utilization of memory resources. Aggregation is essential to ensure high utilization. So the first attempt during updates is to aggregate entries into a small bucket level: just one memory leaf path or two in some cases (as long as an individual path, and overall device level memory bandwidth limits are not exceeded). After the bucket level is exceeded, differentiation within mapping is achieved using bitmap crossproduct function; while maintaining aggregation. Thus the memory leaf resources are highly utilized; hence, achieving high utilization of DQP memory resources.

Sixth, there is support for fast updates. Fast updates are achieved because of very limited modifications to the trie structure. Modifications are limited to one root node (in some cases to only two), where one or two paths are affected during a restructuring and only pointers are moved. Fast updates are also achieved when one or two rows of memory leaf are affected during an update; or with a simple operation the required update path can be reserved and temporary tree resources used to store a burst of updates; or when temporary tree nodes can absorb large update burst and learn a tree structure which is merged with existing root nodes during a maintenance update. Very fast updates are possible with unbalanced or unoptimized tree; and using each stage of the DQP to resolve overflow. The updates can allocated by either the first stage of the DQP, i.e Tag block; or if there is an overflow, by the next stage i.e first mapping can be used to point to memory storage (including leaf memory); and if there is still an overflow at the first mapping stage, then by the second mapping stage to allocate updates. The availability of many degrees of freedom in the DQP thus enable very fast updates with a small loss in efficiency.

Seventh, during updates; trie restructuring are often very limited. Modifications are limited to one root node (in some cases two). In addition, there are relatively few children per trie root node and the crossproduct bitmap function within the mapping stages is highly selective and only one or two paths are affected during a restructuring and only pointers are moved. Further, for lookup tables (or databases) where multiple entries are stored per memory leaf access (or row), at most one or two rows of memory leaf are affected during an update. Also, a tree structure is learnt at every update so that the trie paths are balanced (with a small limit) and never undergo a massive restructuring. Restructuring is always limited to one sensitized path; and involves optimization of the tree structure on that path. For very fast updates zero nodes are modified, update location is resolved by identifying a location pointed by one of the first stages (Tag blocks) or by one of the second stages (Mapping Stage1) or one of the third stages (Mapping Stage2); and can be combined a complex function such as a hash function to select location of update.

Next, there is an ability to store multiple entry types in same device. First, sufficient root node paths (arrays) must be available to process each lookup table (or database) type independently, or simultaneously (in some cases). Second, root and mapping resources should be able to partition lookup table (or database) for various lengths of keys. Third, memory leaf data structures for each entry type must be defined. To support longer width concatenation of words at root node or mapping or at memory leaf is used. Multiple lookup tables (entry types) can be supported either by i) using common root node and different types of leaf entry types (taking the example of a routing lookup tables, although any type of lookup table is supported): a root node constituted of source address (SA) can store IPV4 Flow entries in the leaf node or IPV4 forwarding entries or IPV6 Flow entries and so on; or by ii) entry-specific root nodes for each lookup table or entry type or iii) using a common root node and lookup table (or database) specific mapping. The DQP enables storage content in intelligent formats such as: content storage grammar descriptions, and state traversal tables, and statistical and computing commands can be stored as well; this intelligent content can be further processed by proprietary or well known computing modules.

Ninth, there is support of simultaneous search of multiple tables. The DQP supports multiple tables by using any of the many CAM arrays to store root nodes for different database types. However, the DQP does not need to support the multiple tables used in TCAM to efficiently map ranged entries to optimize width versus TCAM row expansion. Depending on number of parallel database searches the DQP will see an increase in memory bandwidth because additional leaf nodes and mapping nodes need to be read for each database. However the expansion will be limited as this does not apply to similar lookup (or database) tables which have only one or two different fields (as in ranged entry mapping and database lookup tables).

Upon reading this disclosure, those of skill in the art will appreciate still additional alternative systems and methods for a database query processor in accordance with the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An integrated circuit device comprising:
a plurality of mapping memory stages and an associated mapping path processing logic, the mapping path processing logic adapted to compare values stored in a trie structure with query key components and to generate pointers to a mapping memory stage of the plurality of mapping memory stages or to a leaf memory, the leaf memory storing records of information;
a content addressable memory (CAM) adapted to store a breadth first search component of the trie structure which generates an index to access a mapping memory stage of the plurality of mapping memory stages, the mapping memory adapted to store a plurality of values for the trie structure and a plurality of pointers; and
a result generator adapted to compare query key components with a record stored in the leaf memory and to generate a match result along with stored parameters.

2. The integrated circuit device of claim 1, wherein the information comprises one from a group consisting of state tables, grammar, statistical and compute instructions.

3. The integrated circuit device of claim 1, wherein the CAM array can store any part of a record.

4. The integrated device of claim 1, wherein a mapping memory stage of the plurality of mapping memory stages are accessed sequentially to retrieve one of an entry and a record.

5. The integrated device of claim 1, wherein the CAM is a ternary content addressable memory (TCAM).

6. An integrated circuit device comprising:
a plurality of mapping memory stages and an associated mapping path processing logic, the mapping path processing logic adapted to compare values stored in a trie structure with query key components and to generate pointers to a mapping stage of the plurality of mapping memory stages or to a leaf memory, the leaf memory adapted to store information;
a plurality of content addressable memory (CAM) arrays adapted to store a breadth first search component of the trie structure, which generates an index to access a mapping memory, the mapping memory adapted to store a plurality of values for the trie structure and a plurality of pointers; and
a result generator adapted to compare query key components with record stored in the leaf memory and to generate match result along with stored parameters.

7. The integrated circuit device of claim 6, wherein each CAM array of the plurality of CAM arrays comprises a ternary CAM.

8. The integrated circuit device of claim 6, wherein the plurality of CAM arrays are combined to be a wider word width.

9. The integrated circuit device of claim 8, wherein the plurality of CAM arrays comprise a width.

10. The integrated circuit device of claim 9, wherein the width is one from a group consisting of 2 times width, 4 times width, 8 times width, 16 times width, 32 times width, 64 times width, and 128 times width.

11. The integrated circuit device of claim 6, further comprising an output generator adapted to combine results from the result generator and to output results in response to specific query type.

12. A method to allocate a content addressable memory array for each dimension and various node lengths for optimal use of the resources, the method comprising:
comparing values stored in a trie structure with query key components;
generating pointers to a leaf memory, the leaf memory accessed by a pointer storing a plurality of records of information;
storing a breadth first search component of the trie structure;
generating an index to access a mapping memory;
storing in the mapping memory a plurality of values for the trie structure and a plurality of pointers;
comparing query key components with a record stored in the leaf memory; and
generating a match result along with stored parameters.

13. The method of claim 12, further comprising accessing sequentially the memory mapping to retrieve one of an entry and a record.

14. The method of claim 12, wherein the information comprises one from a group consisting of state tables, grammar, statistical and compute instructions.

15. The method of claim 12, further comprising identifying an update location for new records by using at least one of a CAM array, memory mapping stages, a logic function to associated memory, or an external memory.
